(19) United States
(12) Patent Application Publication
(10) Pub. No.: US 2024/0328494 A1
(43) Pub. Date: Oct. 3, 2024

(54) HIGH EFFICIENCY POWER SPLIT CONTINUOUSLY VARIABLE TRANSMISSION

(71) Applicant: Hydracharge LLC, Auburn Hills, MI (US)

(72) Inventor: Jeffrey J. Buschur, Lake Orion, MI (US)

(21) Appl. No.: 18/616,831

(22) Filed: Mar. 26, 2024

Related U.S. Application Data
(60) Provisional application No. 63/577,080, filed on Mar. 27, 2023.

(51) Int. Cl. F16H 47/04

(52) U.S. Cl. CPC F16H 47/02

(57) ABSTRACT

A power split continuously variable transmission (CVT) technology in which efficiency improvements are obtained by elimination of gear meshing at the 1:1 ratio point. A family of power split transmissions are defined using variable displacement hydraulic devices as the variator and employing rotary couplings as speed summers. Input coupled, output coupled and compound coupled systems are described along with impact of and avoidance of power circulation (aka recirculation). Multiple and bidirectional mechanical channel inputs to the speed summer and clutching mechanisms are described enabling transmissions to reach forward gear ratio ranges with a speed of up to 23× with workable efficiencies throughout which can result in improvement in overall efficiency such as in ICE powertrains as well as permitting CVT function in heavy-duty EV powertrains during acceleration or high-grade conditions where otherwise extremely high torque and sustained low speed operations may induce highly inefficient or drive motor overheat conditions.

### RELATED PATENT APPLICATIONS

This application claims priority to U.S. provisional patent application Ser. No. 63/577,080 filed 27 Mar. 2023, entitled “High Efficiency Power Split Variable Transmission”.

### BACKGROUND OF THE INVENTION

For thousands of years mankind has used the contact interaction of two rotating members of differing radii, engaged perhaps with pegs for gear teeth or coupling with crude belts and chains, to convert one form of speed and torque to another. Typically, the mechanisms were used to reduce speed and thus increase torque to gain mechanical advantage for a winch or lifting mechanism. The change in speed and torque combinations were defined as gear ratios of input to output speeds Ni/No.

With the introduction of internal combustion engines and the automobile, mechanisms which allowed selection from a multiplicity of ratios were needed and became known as transmissions. They allowed torque multiplication for vehicle acceleration as well as to allow the engine to return to a relatively narrow range of operating speeds where they operated most efficiently as the vehicle speed increased.

As the world has become ever more energy and carbon emissions conscious it has become advantageous to increase the speed ratios in these transmissions from historically 3-4 forward ratios to 6-12 forward ratios such that the engine speeds could be kept in ever narrowing ranges of operational speed for peak efficiency and minimal emissions. Over the last several decades continuously variable transmissions (CVT's) which have infinite gear ratios have made inroads into the automotive transmission market as they allow engines to operate in even narrower speed ranges for further efficiency and emissions reduction optimization. These CVT's do not have integer fixed gear meshes but rather a friction-based drive-driven interface. Because of this these CVT's are considerably less efficient at transitioning power through various speed and torque changes than gear-based transmissions. Thus, the benefit gained in engine operating points with CVT's is partially offset by a loss in transmission efficiency. What is then needed is means to provide CVT function yet with the highest transmission efficiency possible.

### BRIEF DESCRIPTION OF THE DRAWINGS

The present invention will now be described, by way of example, with reference to the accompanying drawings, in which:

FIG. 1, is a diagram illustrating gear ratios of an 8 speed transmission depicting each of the 8 ratios as a rectangle with corresponding edges on a speed versus torque graph;

FIG. 2, depicts and defines the percentage overlap of each of the 8 rectangles of FIG. 1 with the original input power square;

FIG. 3, provides in closer view illustrating the opportunity of power splitting in gear ratio 5 from FIGS. 1 and 2;

FIG. 4A, is a cross-sectional view of a gearing mechanism designed to minimize meshing losses at a set ratio; FIG. 4B is a graph illustrating this function at various gear ratios.

FIGS. 5A-5D, illustrates both input and output coupled configurations of power split transmissions in both underdrive and overdrive operational modes.

FIG. 6, is a graphical illustration of the efficiencies of an input coupled power split transmission in underdrive at several variator efficiencies;

FIG. 7, depicts positive displacement hydraulic devices forming an output coupled power split transmission;

FIGS. 8A and 8B, are graphical illustrations depicting varying system parameters verses gear ratio for the device of FIG. 7.

FIG. 9, is a schematic illustration depicting an output coupled power split transmission and associated power flows with Ni/No exceeding 1, and an input coupled power split transmission system with power flows associated with Ni/No less than 1, both merging into a compound coupled power split transmission;

FIG. 10, is a schematic of a compound coupled power split transmission as prescribed by FIG. 9;

FIG. 11A, is a schematic illustration of parallel speed summers configured in an output coupled power split transmission; FIG. 11B is a graph showing operating parameters of the device of FIG. 11A, FIG. 11C is an expansion of the graph of FIG. 11B.

FIG. 12, is an arrangement to allow reverse drive input to the device of FIG. 11.

FIG. 13 is a schematic of an input coupled power split transmission with a dog-clutch operable to allow basic hydrostatic operation.

FIG. 14, is a cross-sectional view of prior art of the widely used basic hydrostatic transmission.

FIG. 15, is a cross-sectional view of an internal power split transmission defining prior art of unknown source.

### FIELD OF THE INVENTION

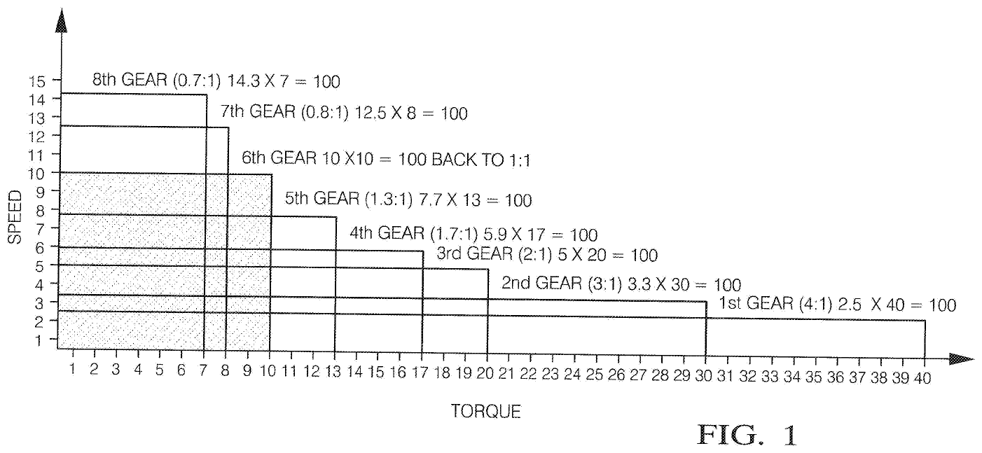

Referring to FIG. 1 we view a diagram illustrating gear ratios of an 8-speed transmission. A familiar equation for power in the English/Imperial system is Power (hp)=TN/5252 where T equals torque in ft-lbs. and N equals speed in rpm. Although there would be different constant(s) dependent on the units of speed, torque and power chosen it would be generally appreciated that power can be represented as a product of speed and torque. For illustrative purposes, if we were to assume an engine power input of ten units of speed×ten units of torque for a total T×N product of 100 units it could be represented by the torque×speed shape shown on a graph with speed units on the vertical axis and torque units on the horizontal axis. Further for simplicity's sake, we will assume 100% efficiency and constant engine input power.

The transmission's task would be to convert this initial 10×10 power product into any one of the rectangles shown representing the 8 available gear ratios. When speed and torque values are multiplied, each rectangle would have an area of 100 units of power. First gear output expressed as 4:1 ratio is for instance 2.5 units of speed at 40 units of torque. Second gear's output is 3:1 ratio or 3.333 units of speed and 30 units of torque. This continues on up to sixth gear where the output gear ratio is 1:1 and the same 10×10 power product form leaves the transmission as came in. Speeds 7 and 8 indicate overdrive where output speed is larger than input speed but output torque is reduced proportionally. These statements are extremely rudimentary to those skilled in the art but they are recited to provide an illustration. The mechanisms in the transmission would send all the input power through an appropriate series of gear interfaces to obtain the desired conversion of speeds and torques. It should be recognized however that this is a multiplication/division transformation that 100% of the power is subjected to. Whatever efficiency losses (if not 100% efficient) there may be, all of the power is subject to them. It should be noted that in 6^{th} gear, where the ratio is 1:1, a solid coupling could be substituted instead of the transmission and none of the power would be subjected to the efficiency losses because none of the power need to be transformed. Most all planetary gear based automatic transmissions have a 1:1 gear ratio in which there is no gear meshing but instead the total mechanism is locked and rotating as a solid member. This is for reference and is the then also generally the most efficient operating ratio.

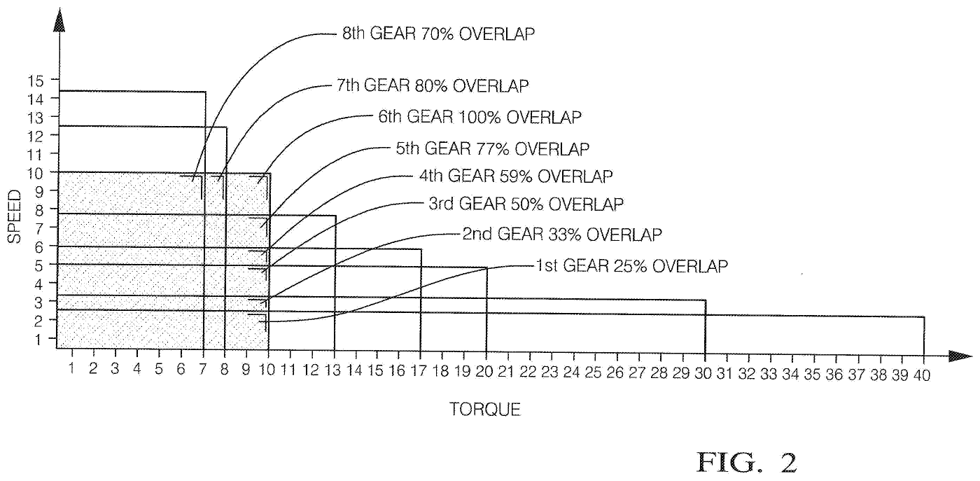

Looking at the same information in the diagram in FIG. 2, each of the 8 shapes depicting the 8 ratios, which are generally rectangular in shape, create an “overlap rectangle” with the original 10 speed×10 torque input product. It will eventually be proven to the reader, that this “overlap rectangle” represents the amount of power which could be passed directly from input to output, given the appropriate mechanisms, without any transitional losses using a technique known as power splitting. It can be readily appreciated as shown in first and second gears that these overlaps represent only 25% and 33% of the total input power. But at the higher and overdrive gears, where vehicle usage percentiles are much higher, these overlaps are very substantial.

Again, it should be noted that the “overlap rectangle” for 6^{th} gear is 100% as there is no transmission function needed. Power splitting introduces the mathematical operations of addition and subtraction into transmission design. This allows avoidance of losses on these “overlap rectangle” percentages as defined. This allows a huge opportunity for efficiency gains in not only CVT's but also potentially in integer gear-based transmissions.

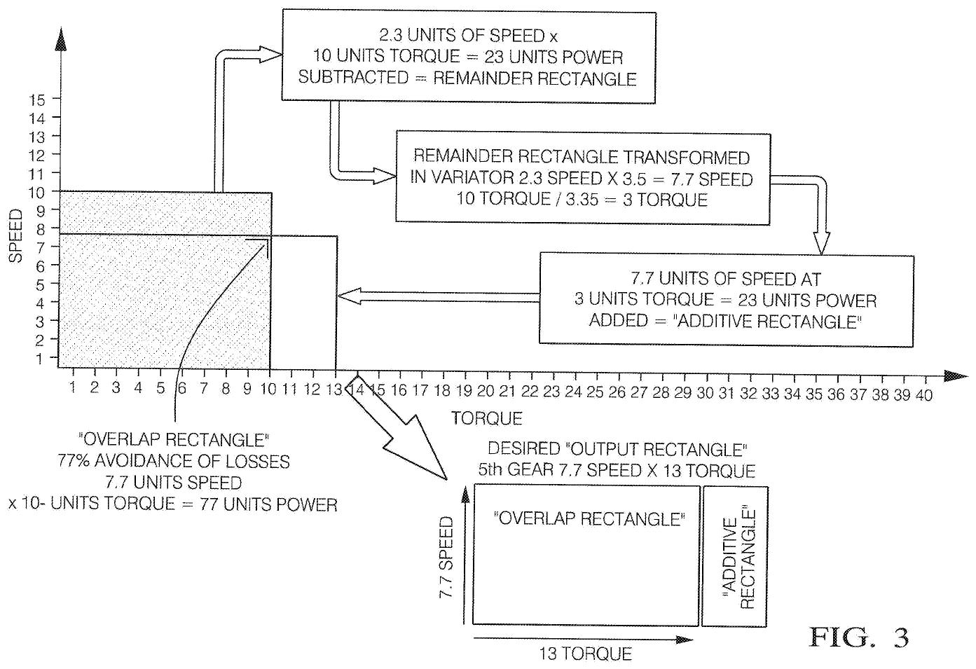

Looking at FIG. 3, a closer view of the operation illustrates the opportunity of power splitting in gear ratio 5 from FIGS. 1 and 2 which is a 1.3:1 ratio. Given again the original input of 10 speed×10 torque and the 5^{th} gear desired output of 7.7 units speed×13 units torque indicates an “Overlap Rectangle” of 7.7 units speed×10 units torque or 77% of power which can avoid the transition losses. To accomplish this 2.3 units of speed×10 units of torque equaling 23 units of power are “subtracted” from the input thus leaving the overlap rectangle.

This 2.3 units of speed×10 torque portion of input power is transitioned through a 0.299:1 ratio (speed increaser) in a multiplication/division operation to result in 7.7 units of speed×3 units of torque. The 2.3 units of speed are multiplied by 1/0.299=3.35 multiplier or 2.3×3.35 equaling 7.7 units of speed.

The 10 units of torque are divided by the same 3.35 factor resulting in 10/3.35=3 units of torque. This is added back to the “overlap rectangle” of 7.7 units of speed×10 units of torque to yield the desired 7.7 speed×13 units torque output.

This graphical based overview of power splitting provides a unique perhaps more pictorially descriptive means to portray that power is “split” into two paths from input to output instead of the historically typical single path. The power represented by the “overlap rectangle” passes straight through on the primary path while the power which needs to be transitioned is subtracted from the input passes through a parallel path where it is transformed and then it is added back to the overlap rectangle to obtain the desired output.

In order to mechanize power splitting, two devices are needed to allow power to be split into a separate parallel power path and later rejoined. First, a “torque junction” provides a means for torque to be added or subtracted from the primary path, most simply explained as a gear on a primary path through a shaft which meshes with a gear on another shaft which allows torque, and thus at some speed power, to be sent to or received from the parallel power path. Another example of a torque junction may be a variable displacement hydraulic pump including a through shaft emerging from the back of the pump and coaxial with the input shaft. Torque on this thru shaft would then be greater or lesser than the amount of torque on the input shaft due to the hydraulically induced torque which is dependent on the hydraulic pressure, and the displacement of the volumetric device. The parallel path power, split off from the primary path, in this case would then be the pressure and flow either entering or leaving the pump.

The second device needed in power splitting and always existing on the primary power path is a “speed summer” which is a more complex mechanism which allows three channels of speed and torque products to merge and interchange with a net zero power gain. The most widely known mechanism supporting this function is a planetary gear set in which the inputs/outputs on the ring, planet carrier and sun gears represent the three channels. Another closely related such mechanism, and also considered a speed summing junction, is the differential gearset in which the two pinions and carrier represent the three channels. Acting jointly, the torque junction and the speed summer allow power to be split off into a parallel path and remerged with the main channel.

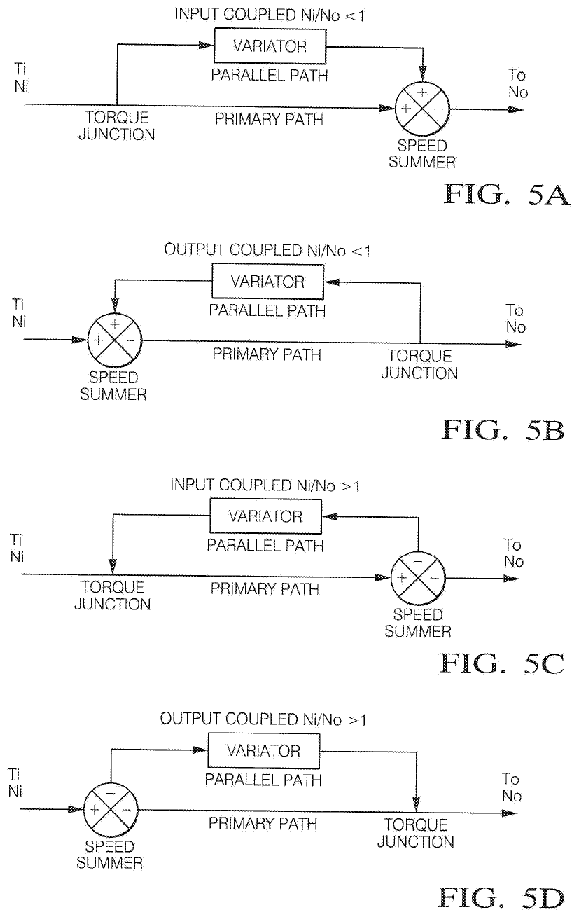

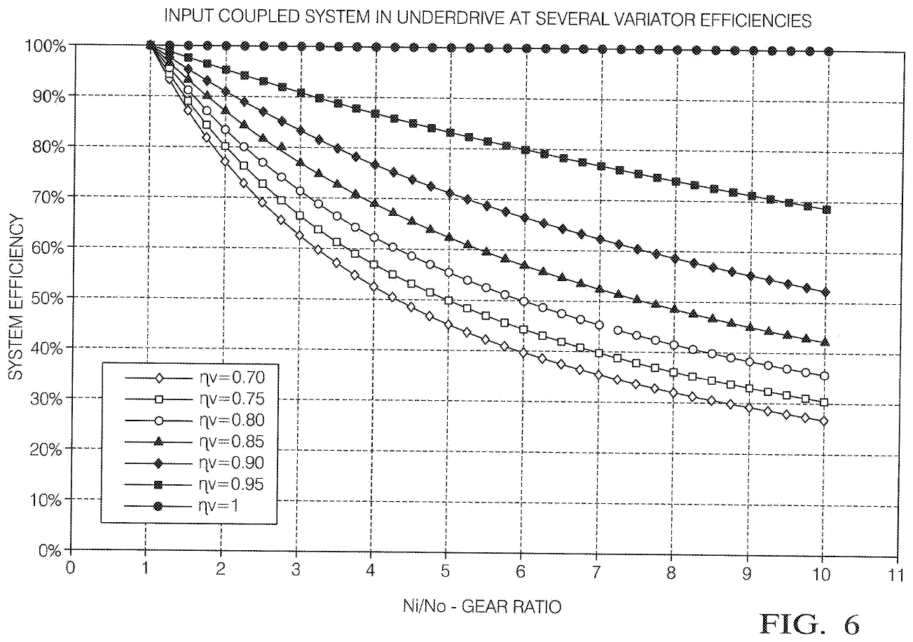

FIG. 5 illustrates the two system configurations of input and output coupled power split transmissions and the two operational situations of underdrive and overdrive in which each of these systems may operate. Input coupled, shown in pictorials FIG. 5A and FIG. 5C, indicates that the torque junction is on the input side of the system. Output coupled, shown in FIG. 5B and FIG. 5D, indicates that the torque junction is on the output side of the system. The two operational modes are where Ni/No is less than 1 or overdrive because the output speed is higher than the input speed and Ni/No is greater than 1 indicating underdrive because the output speed is less than the input speed. “The Variator” shown in the parallel path on each of the four pictorials represents a controllably variable ratio which may be a hydraulic drive, mechanical variable ratio such as a push cone drive or variable electric generator and motor link. The arrows indicate the direction of parallel power flow in each case. The primary path in each of the four pictorials indicates a direct mechanical power path (i.e. the “overlap rectangle” from FIGS. 1-3) which typically has very high or 100% percent transmission efficiency. The parallel power path through the variator typically has a significantly lower power transmission efficiency. By combining the power streams of a less efficient variably controllable parallel path with a high efficiency fixed ratio primary power path a substantially more efficient CVT function can be obtained although it should be realized that even when the parallel path variator is a fixed ratio there would be power savings.

Now taking another look at the directions of the arrows in the four pictorials of FIG. 5A-D, it can be recognized that in A and D the power is flowing in the forward direction through the variator. This situation is referred to as additive power as power moving forward in the system through both parallel paths add together for a resultant output. In the pictorials B and C power is flowing backwards in the variator. In power splitting when power moves backwards in the system it is referred to as circulating power as it means that both the primary and parallel paths will be carrying more and potentially much more than the input power the system. This circulating power can be such a high multiple of the input power that dependent on variator path efficiencies it may in certain circumstances consume all the input power resulting in no output and just a lot of heat. Often, even to those skilled in the art, this may initially be perceived as an impossibility but it is very real and is generally a negative phenomenon. Although fundamental laws of physics indicate this power multiplier cannot be used to produce free power, the system stresses and efficiency losses are real and they must be understood.

If we look at FIG. 5C we see the input coupled system in Ni/No>1 condition. Some portion of speed Ni or more specifically (Ni−No) is sent backward at the speed summer and converted in the variator to add to the input torque at the torque junction. This power retrograde or looping can dramatically increase the torque magnification of the system but at a very significant efficiency cost. If we assign an efficiency of ηv to the transfer function of the variator we can define through algebraic procedures the overall efficiency of the system ηo as follows:

$${η}_{o} = \frac{{N}_{o}}{{N}_{i} + {n}_{v} ( {N}_{o} - {N}_{i} )}$$

### Where: Ni=Input Speed

No=Output Speed
ηv=Efficiency of Variator

FIG. 6 illustrates the function described by the equation above at various Ni/No Gear Ratios and variator efficiencies ηv. It is obvious that even at relatively high variator efficiencies the overall system efficiency becomes quickly unusable as Ni/No increases. Thus, it is preferable to use power split transmissions in additive power mode where the efficiency is near 100% at 1:1 mode and asymptotes to the variator efficiency as more and more power is channeled through it.

Another important difference in the behavior of input vs output coupled split transmissions is that input coupled can reach a zero output “Powered Off” mode while output coupled systems require a clutch mechanism to allow zero output. If you view the input coupled device in FIG. 5A you can recognize that power leaving the torque junction can create motion at the summing junction cancelling out the input speed on the primary pathway and thus allowing an output speed of zero. Now looking at systems FIG. 5B or FIG. 5D both of which are output coupled, as the torque junction is on the output side, leaves no means by which the output can be zeroed.

### FIELD OF THE INVENTION/PRIOR ART

One means by which power split transmissions can be further sub categorized and thus potentially more clearly understood is by defining whether the speed summing mechanism is internal or external to “the variator” branch or the system. External systems utilize at least one, either planetary or differential, gearset “external to the variator branch” to sum the speeds of two or more parallel power paths. Also, in an external power split system there will be one or more torque summing junctions to reconnect parallel power flows. Further, in external power split transmissions the mechanisms comprising “The Variator”, be they hydraulic pumps and motors, motor-generators, friction drives or even discrete integer gear ratios, are mounted in a stationary manner and thus allowing one or more torque reactions to ground. In an internal power split system, the torque splitting and speed summing operations are integrated. There is no externally identifiable parallel power path. There is one input channel and one output channel and typically a housing or other member capable of conveying the torque reaction to ground.

There are numerous external power split transmission designs patented and widely in production today using a planetary gearset as a speed summer. Typically, these are of input coupled design with either the sun or ring gears linked to the input torque junction by the variator with the primary mechanical path being applied by the alternate while the output is taken by the planet carrier. The said ring or sun gear is held stationary by “The Variator” mechanism to product the most efficient operating point for the system where no power is moving through the parallel variable path. However, with external power split transmissions designs, even at this most efficient operation point 100% of the power is still being transferred through meshing gears of the other two power channels representing a loss of efficiency.

Despite this encumbrance planetary gearset based technology is used for power splitting and particularly CVT power-split transmissions for construction and agricultural products typically in the higher power range portions of the product line. External power split transmissions are now the dominate form of power management in construction and AG equipment in power levels over 150 hp. CVT operation is more important in these product lines than in over the road vehicles because construction and agriculture usage often requires that the vehicle operates for extended periods at specific speeds which may not be coincident with any particular speed in an integer speed ratio gear based system.

As previously mentioned, the second general category of power split transmissions are defined as internal. To begin explanation of the workings and design difficulties of internal power split transmissions, using the commonly known hydrostatic transmission as a reference is an appropriate starting point.

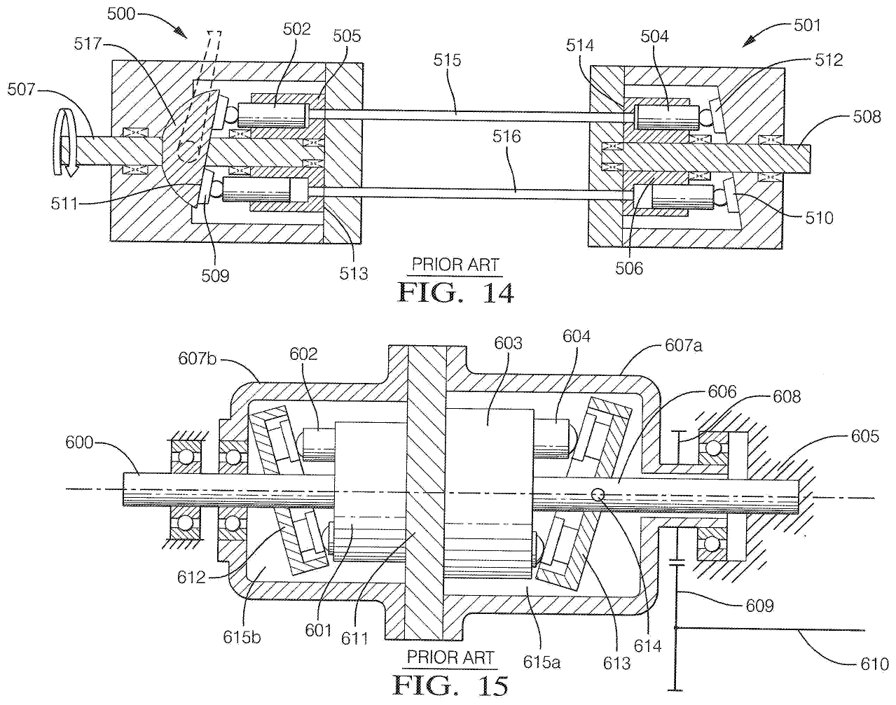

Referring now to FIG. 14, hydrostatic transmissions are very commonly used in off-road equipment as they allow continuously variable drive ratio operation in a reliable, durable and easily packaged solution. The most common design is comprised of a hydraulic pump 500 and motor 501 in each of which a multiplicity (generally 9) pistons 502 and 504 stroke axially in rotating cylinder blocks 505 and 506, similar to a six-shooter pistol, are affixed to the pump input shaft 507 and motor output shaft 508. The piston ends (or shoes) 509 in pump and 510 in motor ride on plates 511 in pump and 512 in motor which angled relative to the axis of cylinder block(s) rotation which defines the sinusoidal axial stroke of the pistons and also converts their pressure induced axial forces into torques. Opposite the angle plates (and piston shoes) on the other end of the cylinder blocks are another set of plates 513 in pump and 514 in motor perpendicular to the drive shafts known as valve plates. These valve plates have kidney shaped slots in them which control when each piston's cylinder bore is in communication with inlet and outlet passages. The inlets and outlets of the pump and motor are connected by conduits 515 and 516 either of which are passageways inside a common housing or hydraulic hoses potentially many feet long traveling from an engine mounted pump to a wheel mounted motor. The angled plate(s) may be fixed as 512 in motor 501 or movable as 511 in pump 500 by some mechanism in which case they are known as a swash plate 517. If either the pump, motor or both have controllable swash plates changing the plate angle(s), and thus the stroke of the pistons axial travel, they control the displacement of the respective device. By changing the displacement ratio between the pump and motor, a variable ratio drive is created.

Most commonly the swash plate angle in these pumps can be controllably varied through the zero-angle position to reverse the torque to pressure relationship to allow seamless reverse direction operation to generally the same magnitude as in the forward direction. When the swash plate 517 can traverse controllably through the zero angle it is referred to as “over center” capable. Accordingly, when the pump goes “over center” the polarity of the pressures of the hydraulic passages reverse requiring that all working passages be capable of the high working pressure as such they are essentially constructed interchangeably. Given that low pressure drainage passages to tank are still necessary a “closed loop” configuration is adapted in which there is a high working pressure, low working pressure and tank circuits. The low working pressure is maintained at a minimum pressure level (i.e., 300 psi) by an auxiliary pump with a cadre of check-valves and relief valves to accommodate pressure polarity reversals. This “closed loop” adaptation essentially eliminates most all cavitation and aeration issues normally associated with hydraulic circuits, despite even frequent and rapid pressure polarity reversals, but comes at the cost of the power draw of the separate auxiliary pump.

In a typical hydrostatic transmission, the pump, which produces the hydraulic flow at system pressure, and the motor, which converts it back into torque and speed mechanical energy, have their respective valve plates and fixed or variable swash plate(s) angularly fixed as they are both stationary to ground. This means the valve plates, fixed angled plates and swash plates remain in proper angular alignment for required fluid passage commutation by default and nobody has to give it a second thought.

The intended goal and advantage of an internal power split design is to arrange the cylinder blocks, angle plates, valve plates and respective housing(s) of the hydrostatic transmission pump and motor into two devices comprising the required speed summer and the torque junction (reference FIGS. 5A-5D) in a manner that flow produced by a set of axially stroking pistons in one cylinder block can be transferred directly to the axially stroking pistons in the opposing cylinder block without having to leave the local rotating framework. This could be the case if everything to the right of and including valve interface block 513 in FIG. 14 were attached to and rotating with input shaft 507 with exception of pistons 504, cylinder block 506 and output shaft 508. In that case depending on relative displacements of the action at the two cylinders, a power split will occur with a portion of power transferred hydraulically and the remainder through another parallel path mechanically. If the axial stroke of the pistons in the device comprising the torque junction, in this case pistons 502, can be controllably varied, the speed ratios and therefore the proportions of hydraulic versus mechanical power transfer between the cylinder blocks can be varied creating a very efficient and compact power split transmission.

Resistive load torque on shaft 508 would depending on the displacement of hydraulic motor device 501 create a hydraulic pressure. This pressure would create a reactive torque in device 500 which in this case is the torque junction. As the axial stroke of pistons in the cylinder block of this torque junction interact with the hydraulic pressure and flow a speed ratio is established. If by changing the swash plate angle, the speed ratio between the torque junction and the speed summer can be adjusted, the percentage of power transferred through the parallel path can be controlled. Reducing the swash plate angle of the torque junction reduces the amount of hydraulic power passing through the parallel path. If the swash angle in the torque junction is reduced to zero there can be no hydraulic flow exchanged between devices and power is transferred at 1:1 ratio purely mechanically at very near 100% efficiency.

In such an “internal power split transmission” there is however a huge design challenge to maintain proper commutation between the two sets of pistons. The two sets of pistons (motor and pump) in each of the respective rotating cylinder blocks have to exchange flow in an angularly coordinated manner to prevent cavitation, direct high pressure to low pressure leakage and/or hydraulic lock as drive ratios change. The sinusoidal axial oscillating motion in each set of pistons is dependent on the angled plates on which the pistons ride. The associated valve plate openings need to remain angularly coincident to this sinusoidal function. Despite this, the period and phase angle of the sinusoidal oscillations of the pistons in the two-cylinder blocks must be different from each other for varying speed ratio and for the power split function to occur. Thus, an internal power split transmission must resolve this issue.

If both valve plates, fixed angle plates and swash plates remained angularly aligned, even though they are all rotating at some common angular rate with a common phase angle, this can be accomplished.

Referring to FIG. 15, a swash plate structure/pump of unknown origin is an illustration of such a system. FIG. 15 is a diagram of unknown origin illustrating such a system.

The input shaft 600 rotates a first cylinder block 601 containing the first set of axially stroking pistons 602 at an input speed of N1. A second cylinder block 603, containing a second set of axially stroking pistons 604 does not rotate and is stationary as it is anchored to ground 605 by stationary shaft 606. An all-encompassing housing 607a-b rotates coaxially, however typically at a different speed than the first cylinder, and includes the output member 608 of the mechanism at speed N2. It is shown engaging some offset external mesh gear 609 to move the output shaft 610 off center from axis of the general mechanism. Rotating with the overall encompassing housing 607a-b and anchored angularly to is the valve plate 611 providing fluid communication between the two, cylinder blocks 601 and 603 and both the fixed angle plate 612 anchored to rotating housing 607a-b and/or controllable angle or swash plate 613 which can be controllably tilted around axis point 614 which turns with overall enclosure 607a-b. Although shown simply as a pivot around axis 614 the support mechanism of controllable angle plate 613 must be constructed in such a fashion as to not interfere with the rotation relative to shaft 606.

It can be appreciated therefore that the first set of pistons 602 would be driven axially with a sinusoidal motion with a speed defined by the relative motion between the input shaft 600 at N1 and the fixed angle plate 612 rotating with the housing 607a-b at speed N2 resulting in a sinusoidal driving speed of N1-N2. The second set of pistons 604 would be actuated by the relative angular motion between output N2, which is also the speed of the overall housing 607a-b, and cylinder 603 which is anchored to ground. However, in the mechanism shown, since valve plate 611 and both angled plates 612 and 613 are all rotating together in unison at speed N2 communication or commutation allowing proper flow occurs without issue between the two sets of pistons 602 and 604 which are stroking at different sinusoidal periods.

This means, however, the movable and controllable swash/angle plate 613, contained in the all-encompassing housing (aka containment vessel) 607a-b, has to be rotating at up to several thousand rpm. It must be receiving from the outside world a control input and execute that control input to provide angular control of the swash plate's 613 angle relative to rotating enclosure 607a-b to control transmission drive ratio against high pressure forces while maintaining rotational balance all the while enclosed in the containment vessel at a high rate of rotation. Also, the leakage, which would collect in the containment vessel cavities 615a and 615b, must be pumped back into the low-pressure side of the circuit. Due to these engineering difficulties, this type of internal power split transmission has not been known to be reduced to commercial practice.

Honda U.S. Pat. Nos. 7,082,761, 7,076,948, 7,629,909 and 7,000,388, among others, define a more practical solution to the internal power split transmission communication issue. The Hondamatic ATV transmission is an “internal” power-split transmission which accomplishes the communication or commutation task with what are called distributor valves. In the Honda design, the input N1 rotates a fixed angle plate which drives the pistons in a cylinder block which is rotating in unison with the output shaft. Another cylinder block also rotating in unison with the output shaft has its pistons traveling a sinusoidal axial stroke driven by a controllable swash plate which is mounted stationary to ground. Having the controllable swash plate in a stationary yoke mount makes this a very workable design from a balance and control signal transmission standpoint. But the communication issue still needs to be resolved.

Between the two-cylinder blocks are packaged the distributor valves. The distributor valves are an arrangement of radially moving pistons which are driven by eccentrics on N1 and N2 rotation rates which coordinate communication between cylinder blocks as angular relationships of communication change with varying drive ratios. The radial pistons open and close allowing communication to occur for proper commutation between the axial moving pistons, and high-and-low pressure ranges accordingly to match the N1 and N2 driven communication rates.

The Japanese tractor manufacturer Yannar has an internal power split transmission design in production commercially called the i-HMT(Vario). No US patents are known at this time but all indications are it is based on distributor valves similar to the Hondamatic. The advantage of this distributor valve design approach whether Honda or Yanmar is complexity and the restriction to flow caused by the intricate passages through the valving which must all be packaged in very confined space.

U.S. Pat. Nos. 9,915,192 and 10,927,936 to Buschur define a technology by which a positive displacement hydraulic device acting as either a pump or a motor has half of the device comprised on the input shaft and the other half of the device comprised on the other such that both are rotating coaxially. Relative motion between the two halves thus produces flow as a pump or consumes flow as a motor while the flow regardless of function is transported on and off the rotating assembly through use of rotary fluid couplings. The defined device creates a speed summing junction functionally equivalent to a differential gear or planetary gearset in that it constitutes three I/O channels. Input shaft, output shaft and hydraulic flow on and off the assembly. The Buschur device described in the above-described US patents would appear to fall into the external category of power split designs as fluid flowing through stationary lines clearly defines the parallel power flow path, but torques produced between two angularly moving members construe the definition of internal and external systems.

### DESCRIPTION OF THE PREFERRED AND ALTERNATIVE EMBODIMENTS OF THE INVENTION

It is the intent of the invention to optimize the principle of power-splitting to create a subcategory of transmissions that operate at the highest possible efficiency levels and provide the greatest possible range of ratios. This will seek to avoid gear meshing and shear losses particularly in the primary power path or mechanical channel. As a sub-strategy it will employ a variable ratio means, which is not dependent on any frictional interface, to create an efficient form of continuously variable transmission designs which generally avoids or minimizes discontinuities such as clutch actuations.

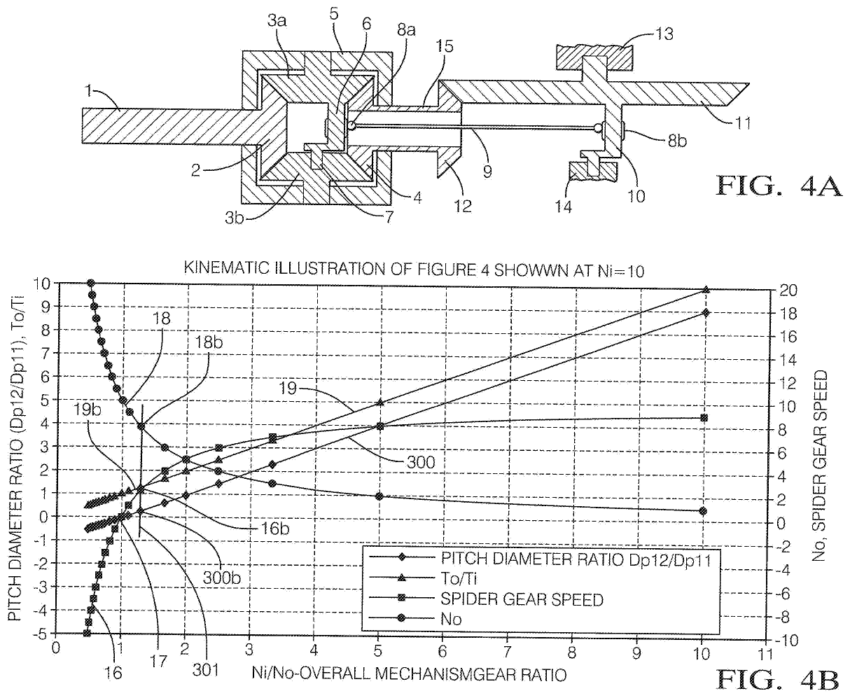

Now as a first embodiment and referring back to FIGS. 1-3 we will describe another way how the operations of subtraction, multiplication/division and finally addition, described particularly in FIG. 3, could be physically accomplished. FIG. 4 is a cross-section of a mechanism including both differential and bevel gear modules. Input shaft 1 is integral to pinion gear 2 which engages spider gears 3a and 3b. Spider gears 3a and 3b both engage pinion gear 4. Gears 2, 3a, 3b, and 4 all have rotational joints housed in carrier 5. However, whose axles of 2 and 4 are 90 degrees out of plane with those of 3a and 3b. Together these aforementioned items comprise what can be recognized by those skilled in the art as a differential gear set.

Spider gear 3a has an eccentric extention cam 6 which is further supported by a bearing journal 7 in spider gear 3b. Coaxial to the eccentric cam is ball joint sleeve 8a. Connecting rod 9 couples to another ball joint sleeve 8b which is rotationally constrained to eccentric cam 10. The eccentric cam 10 is an extension of bevel gear 11. Bevel gear 11 and associated eccentric cam 10 are supported by bearing journals stationary to ground 13 and 14. The eccentricities of cams 6 and 10 are equal so gears 3a and bevel gear 11 are coupled and turn at equivalent speeds. However, it should be recognized that bevel gear 11 could turn opposite to gear 3a.

The stroking motion of connecting rod 9 will not be affected by revolute motions of pinions 2, 4 or carrier 5. However, there will be a superimposed slight oscillation caused by the out of plane motion of joint 8a. The eccentric of cam 6 is illustrated at bottom dead center position. At this position ball joint 8a could remain absolutely motionless despite revolute motion of carrier 5. However, if cam 6 were rotated out of plane 90 degrees in either direction the rotation of carrier 5 would create a wobble motion on connecting rod 9. This would cause a motion on sleeve 8b driven by the rotational speed of carrier 5 with the magnitude M defined by:

$$M = \sqrt{{x}^{2} + {y}^{2}} - y$$

### Where:

X=eccentric of cam 6 to rotational center of gear 3a
Y=length of connecting rod 9
M=magnitude of oscillation

Wherein M would be maximum when both eccentrics of cam 6 and cam 10 are 90 degrees out of plane so unless M exceeds the eccentric of cam 6 or cam 10, it would not damage the system, but the vibrations would likely be quite objectionable however for the purposes of overall transmission function, axial stroking of connecting rod 9 will only respond to relative rotation of spider pinion 3a to carrier 5. Engaging bevel gear 11 is bevel gear 12 which in turn is integral to pinion gear 4 and comprises in total output member 15. The pitch diameter of gear 11 is 1/0.298 or 3.356× the pitch diameter of bevel gear 12.

To review functionality of the device we first look at angular motions. The equation of motion for a differential gear set is well known as:

$${ω}_{a} + {ω}_{b} = 2 {ω}_{c}$$

where a and b are angular rotations of the two pinions, here 2 and 4, and c is the angular rotation of the carrier 5. Thus, it can be written:

$$\frac{{ω}_{a} + {ω}_{b}}{2} = {ω}_{c}$$

Such that the carrier will always rotate at the average speed of the two pinions.

As input shaft 1 integral with pinion gear 2 rotates 10 revolutions the defined or desired output at pinion 4, which is integral to the output number 15, is to be 7.7 revolutions to match gear ratio 5^{th} gear 1.3:1 ratio as shown in FIG. 3. Pinion and spider gears 2, 3a, 3b and 4 all have equal pitch radii, thus pinion 3a will turn at a speed of 10−7.7=2.3 revolutions within carrier 5 which will be turning at a rate of (10+7.7)/2=8.85 coaxially with pinions 2 and 4. The ball joint sleeves and connecting rod 9 will thus drive bevel gear 11 at a rate of 2.3 revolutions per 10 revolutions of the input shaft. Bevel gear 11 has a pitch radius of 3.35× that of bevel gear 12. The drive ratio of bevel gear 12 to bevel gear 11 is thus 0.298:1 such that a 2.3 revolution speed at gear 11 will result in a 1/0.298×2.3=7.7 revolutions speed at gear 12 matching the desired speed on output member 15.

Further reviewing mechanism torque balances. The torque equations for a differential gearset are:

$$Ta = Tc / 2 Tb = Tc / 2 Ta = Tb$$

Ball joints 8a and 8b due to the nature of their construction cannot create a torque coaxial to the rotation of pinions 2, 4 and carrier 5. The resistive torque on pinion 4 is thus equal and opposite to the input torque of 10 units on pinion 2. Compressive and tensile forces in connecting rod 9 can however resist rotation of spider gear 3a around its revolute joint within carrier 5.

The torque on carrier 5 is according to the equations is twice that of the pinions 2 or 4 or equal to 20 units of torque. This torque, however is acting not relative to stationary ground but rather relative to angular movement of member 15 and thus at a relative speed of 8.85-7.7=1.15 revolutions relative to member 15. The resistive torque caused by compressive or tensile loads in connecting rod 9 create a torque on spider gear 3a resisting this torque on carrier 5 through the pivot joint between them. The axial loads in member 9 will be a sinusoidal function but the torque induced on spider gear 3a will be an inverse ratio to its rotational speed versus the relative speed of carrier 5 to output member 15. Or 1.15/2.3×20 units torque=10 units of torque. Alternatively, given that pinion 2 and spider 3a have equivalent pitch diameters a 10 unit counter torque on 3a will balance the input torque on 2. Thus 10, units of torque at speed of 2.3 revolutions will be transferred through the connecting rod 9 to bevel gear 11. The 10 units of torque in bevel gear 11 at 2.3 revolutions will induce a torque relative to stationary ground on bevel gear 12 of 1/3.35 or 0.298×10=3 units of torque. Thus, 3 units of torque will be added by bevel gear 12 along with the 10 on pinion gear 4 to create a total output of 13 units on output member 15.

Thus, the mechanism also completes the algorithm as defined by FIG. 3. This mechanism is clumsy and fraught with potential problems but shows again in principal that the actions defined could be accomplished. The 5^{th} gear ratio in the transmission as illustrated in FIG. 1 is 1.3:1 and thus could be completed with a simple single stage gear mechanism with an output gear 1.3× the pitch diameter of the input gear however in this method 100% of the power would be transferred through the meshing losses. Estimating such a gear set would have a 97% efficiency there would be a 3% overall loss of power.

In the complex mechanism described there would be two gear mesh losses, one in the differential gear transferring power top spider 3a and a second in the meshing of bevel gear 11 to bevel gear 12. If we assume the same 97% for both these meshes the transfer losses would be:

$$Gear Meshing Losses = ( 1 - 0.9 {7}^{2} ) = 0.059$$

or nearly a 6% loss.
However, because 77% of the power transfers through the differential from pinion 2 to pinion 4 without relative motion and associated meshing losses the actual outcome would be:
23 units of power passed at 94.1% efficiency=21.64 units
77 units of power passed at 100% efficiency=77.00 units
Power arriving at output member 15=98.64 units

Total efficiency=98.64/100=98.64% or 1.36% of power lost. Comparing this to the basic single stage loss of 3% indicates: (3−1.36)/3=0.55. The power split mechanism would reduce meshing losses by 55% as compared to a standard single gear mesh equivalent of 1.3:1.

Of course, we are being optimistic in assuming no losses in the ball joints and sleeves etc. thus this is in essence only of academic value. There is however, rolling bearing constructed sleeve and ball bearings such that the friction of these members could be nearly incalculably low but gear meshing friction is generally unavoidable.

The challenge in the mechanism is to transfer the power which is released by the controlled intentional angular slippage within the speed summer device, in this case a differential gear, from the rotating reference frame to a stationary reference frame such that it can be added back to the output member by reaction against a stationary reference.

It should be recognized that the pitch diameter ratio of bevel gear 12 to bevel gear 11, in this case 0.298:1, is controllably operable to define the overall ratio of the mechanism at 1.3:1. As the pitch diameter ratio of the gear 12 to 11 decreases (i.e. Dp12/Dp11=Pitch Diameter Ratio), such that Dp12 is very small and Dp11 is very large, the overall mechanism ratio will approach 1:1. In fact, it would be as though gears 11 and 12 were removed and joint 8b was locked stationary to ground. The mechanism would create a 1:1 ratio with no gear meshing occurring at all and 100% power transfer would occur. Alternatively, any of an infinite number of fixed gear ratios could be arranged between 11 and 12 to create a resulting infinite number of overall mechanism gear ratios to equate to any rectangular relationship between input and output as set forth by FIG. 1.

Looking now to FIG. 4B, these relationships can be more easily understood. It portrays operating parameters vs overall mechanism Ni/No or gear ratio with an input speed or Ni of 10 rpm. Line 18 indicates the mechanism output speed, which is member 15, read on the right-hand axis. Line 16 indicates the angular speed of the spider gears 3a and 3b turning within carrier 5. Note that point 17, which is at 1:1 gear ratio, the output speed as shown on line 18 is 10 rpm and the spider gear's speed on line 16 is zero (both shown on right side axis). However, as output speed exceeds input speed, the spider gear rotation reverses and goes negative which, in turn, determines that gear 11 would also be turning in a negative direction.

Line 19 depicts To/Ti (or output torque divided by input torque) and is such 1.0 at point 19b. Line 300 depicts the Pitch Diameter Ratio Dp12/Dp11 which approaches zero as shown also at point 17. This would mean to reach 1:1 ratio, an infinitely large gear 11 or, conversely, an infinitely small gear 12 would be required. This is theoretically possible but reasonably infeasible using gears but is functionally equivalent to a hydraulic closed circuit over center variable displacement pump moving through the zero-angle swash plate position.

Line 301 indicates the 1.3:1 ratio-conditions of 5^{th} gear from FIG. 3 as previously discussed. Point 300b indicates the Pitch Diameter Ratio of 0.298 required with for an output speed of 7.7 shown at point 18b and spider gear's speed of 2.3 rpm shown at point 16b again both read on the right-side axis.

The presently described mechanism has a fixed gear ratio transitioning the power which was subtracted from the primary power pathway and transformed in the form which is additive at the gear 11 to gear 12 interface. The percent of power diverted is directly proportional to spider gear speeds, thus at the 1.3:1 gear ratio point the spider gear's speed of 2.3 rpm with an input of 10 rpm indicates that 23% of power moves through the side branch and 77% incurs no transition and thus no losses.

Typically, in power split transmissions this side channel pathway allows for a controllably infinite number of ratios and is called “The Variator”. The variator could be a push chain cone, toroidal, hydrostatic or even motor-generator variable link. The interface ratio between gears 11 and 12 could also be a multiple speed integer transmission such as a manual, automatic or Dual Clutch transmission. In any of these subvariants, the benefits of power splitting could be accomplished according to the theory defined by FIGS. 1-3 and supporting text.

The complex mechanism such as the oscillating member 9 of the aforementioned device is obviously less than ideal. This complex oscillating mechanism (i.e. 6, 8a, 9, 8b, 10) could be avoided in the case of a differential gear usage as the speed summer by allowing the output to be subjected to a −1:1 gear ratio. This −1:1 alternative conversion means the output pinion 4 would rotate in the reverse direction of the input pinion 2 by meshing of the spider gears 3a and 3b, however the carrier 5 would be at that point stationary. In this case, the angular slippage in the carrier for the output to be 7.7 revolutions with the input being 10 revolutions could be transferred from the carrier motion of being (10+(−7.7))/2=1.15 revolutions of motion at 20 units torque relative to stationary ground could be directly coupled between the carrier and the output pinion using a simple appropriate gear ratio. The disadvantage would be that the −1:1 gear ratio of input pinion 2 to output pinion 4 would be a constant gear meshing loss on the straight through power transferred, thus partially defeating the purpose of power-splitting.

Just as in this afore-mentioned power split system, using −1:1 differential gear as a speed summer, it is important to recognize that the widespread use of planetary gearsets as speed summers to enable power-splitting also has the exact same deficiency. When the variator side channel is transferring no power, and thus at the highest overall system efficiency point, there is still within these systems an ongoing power loss due to gear meshing loss within the planetary speed summer.

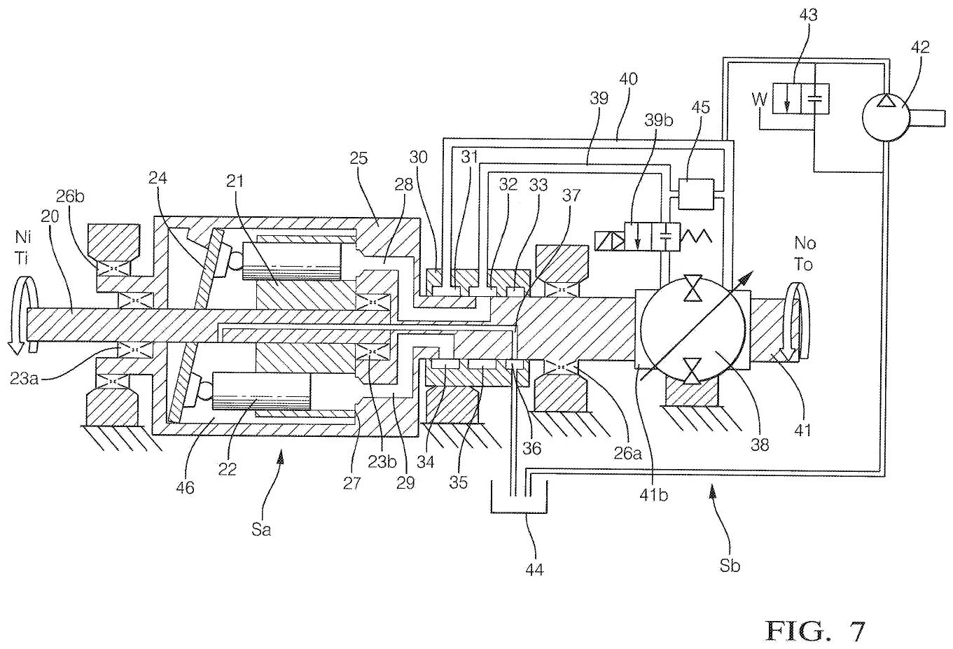

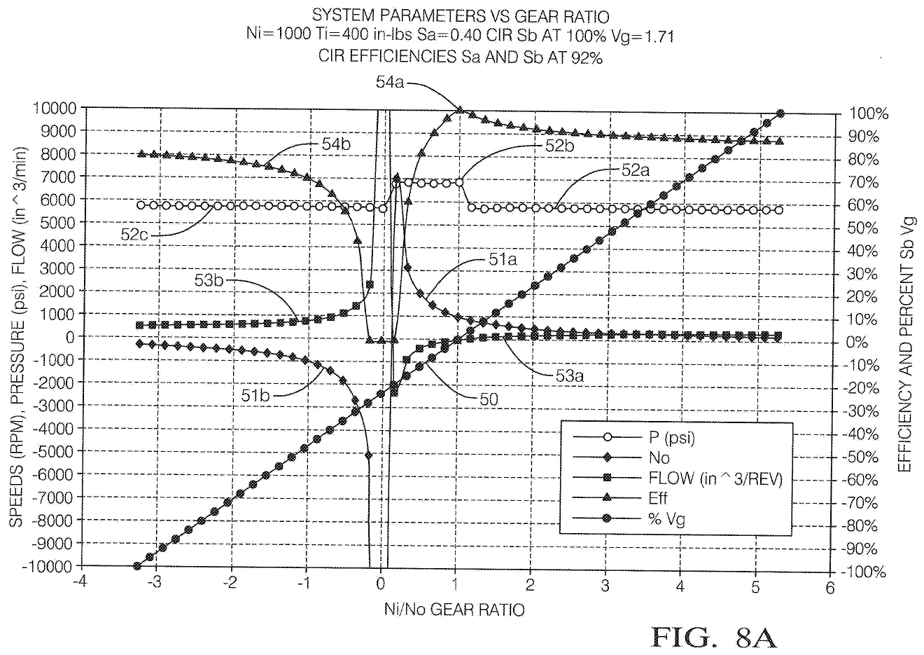

Now referring to FIG. 7, based on positive displacement hydraulic devices and defining another preferred embodiment is illustrated a cross-section of a form of power split transmission in an output coupled configuration. Again, output coupled is defined as having the torque junction on the output side of the power split transmission. Looking to the left side of FIG. 7, output shaft 20 is affixed to cylinder block 21. Within cylinder block 21 are housed a multiplicity of but often 9 axial pistons 22. Shaft 20, cylinder block 21 and axial pistons 22 constitute the input assembly and all revolve as an assembly supported in bearings 23a and 23b. Given hydraulic pressure, axial pistons 22 create force upon angled plate 24 creating a torque on member 25 relative to cylinder block 21 and shaft 20 which is supported by bearings 26a and 26b coaxial with rotation of items 20, 21 and 22. Axial movement of pistons 22 displace a fluid volume given relative motion between the input (i.e., items 20 and 21) and output assemblies (i.e. member 25). This fluid volume is communicated through valve plate 27 allowing passage of fluid in and out of passages 28 and 29 in body 25. A rotary fluid coupling assembly 30 has appropriate concentric openings 31 and 32 to allow axial passages in 25 to communicate with stationary rotary coupling housing 30. This, in turn, allows communication through external fluid lines 39 and 40 to communicate to closed circuit over center variable pump 38. Further, there is a third passageway 37 in output member 25 which communicates with concentric feature 36 in rotary coupling 30 to allow leakage from the pistons and valve plate collected in cavity 46 to drain to reservoir 44. Pump 38 has a through shaft construction such that member 25 continues through pump 38 to comprise output shaft 41. There is also a bypass valve 45 positioned between lines 39 and 40. Since as mentioned, this is a closed-circuit pump system, an auxiliary pump 42 provides a steady lower leg pressure to line 40 which is regulated by relief valve 43. Thus, this pump returns any drain flow passing through to reservoir 44 as well as any internal pump leakage through (pump drain passage not shown) back into the active circuit passing through passages 39 and 40.

The input member consisting of 20, 21 and pistons 22 thus turns relative to the overall member 25 with flow either being produced or consumed by the direction of relative motion between them. It should be recognized that the angled plate 24, and valve plate 27 are affixed to member 25 which is normally the stationary housing of an equivalent fixed displacement pump or motor. Thus, this motor or pump, which is normally in a stationary frame, is now rotating coaxially with the hydraulic flow being transferred to or from the stationary reference frame through the rotary coupling 30. This relative interaction of input member, output member and hydraulic flow, offloaded through the rotary coupling become a 3-channel summing junction similar to the function of a planetary gearset or as discussed earlier a differential gearset.

Given motion at input 20, if the controllable displacement of pump 38 is set at zero swash plate angle no flow will be able to flow through passages 39 and 40. Thus, despite pressure on pistons 22 proportional to torque at input 20 the pistons will not be able to move axially against swash plate 24 and cylinder block 21 and member 25 will essentially be locked together at 1:1 and all power will pass mechanically through to member 25 and output shaft 41 at efficiency very near 100%.

It must be recognized that at this 1:1 ratio operating point, although no power is moving through the hydraulic branch the load torque acting through mechanism Sa as a pump would pressurize line 39. There would therefore still be leakage in both mechanisms Sa and Sb which would represent a slippage loss. If the valve as shown at 39b which could operatively place a check-ball in the passage 39 when this condition occurs the pump Sb would not suffer leakage from this pressure and performance would be improved. Fluid could still flow towards Sa in line 39 in the unactuated valve state through the check-ball. The valve would be actuated when allowing high pressure flow from Sa to Sb was beneficial.

If the swash plate angle in pump 38 (aka Sb) is controllably set to an angle which allows flow to move through passages 39 and 40 such that input 20 turns at a higher angular rate than output 41 the pump 38 will function as a motor generating torque relative to ground and adding to the output torque. In that case, the proportion of movement output/input would be the amount of power transmitted without loss and the remainder would move through the hydraulic power path. Thus, referring back again to FIG. 3, for instance if the input speed were 10 and the output speed was 7.7, then 7.7/10 or 77% of the power would be transmitted mechanically at 100% efficiency. If we define the fixed displacement caused by relative movement between items 21 and 25 in cc/rev as Sa and the displacement at the specified swash angle of the pump 38 in same cc/rev as Sb the torque relationship of input to output would be represented by the equation:

$$\frac{{T}_{o}}{{T}_{i}} = \frac{( {S}_{a} + {S}_{b} )}{{S}_{a}}$$

In this case the system would be operating in additive mode because the power moving straight through 20 to 41 would be essentially lossless and the power leaving the displacement device Sa would be moving forward to unit Sb thus not getting into power circulation which multiplied losses. It would be functioning as Output Coupled in Underdrive in Ni/No>1 FIG. 5D.

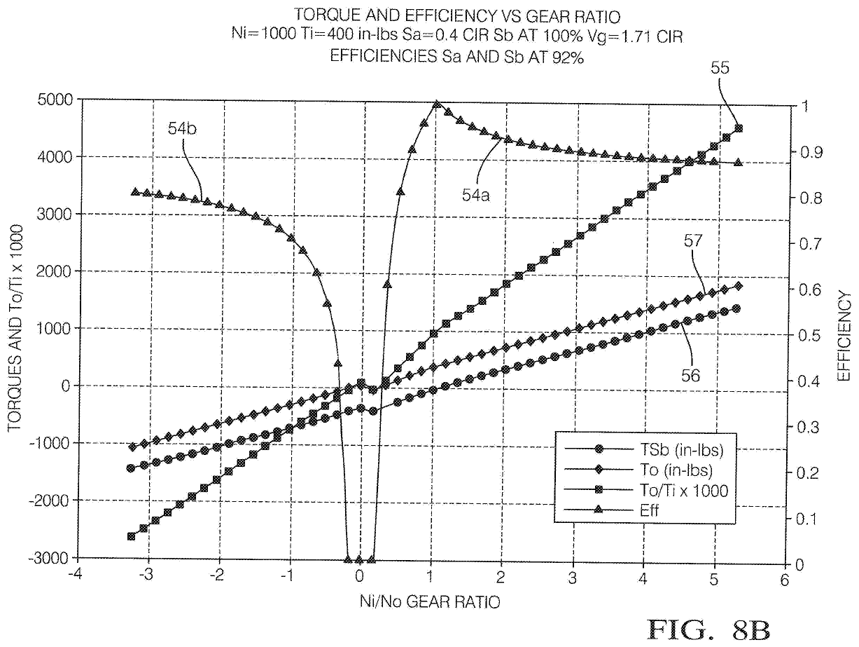

Now referring to FIGS. 8a and 8b the operating characteristics of the device as described in FIG. 7 will be explained. FIG. 8a depicts the function of the device given displacement of Sa=0.4 cubic inches per rev (CIR) and device Sb having displacement of 1.71 CIR at 100% swash plate displacement or 100% Vg. The input to model is Ni=1000 rpm and Ti=400 in-lbs. Efficiencies of both hydraulic devices are modeled at 92% each. Line 50 indicates the percentage Vg from −100% to 100% which is the controllable input parameter of the system enabling infinitely variable Ni/No or gear ratios from −3.25:1 (reverse) to 5.28:1 (underdrive). It should be noted that when Vg is at 0% the drive ratio is at 1:1 and the efficiency of the system is essentially 100% as depicted by 54a. As the Vg % line 50 increases the output speed line depicting No declines to a low of about 190 rpm or a 5.28:1 underdrive ratio. The maximum underdrive ratio is limited to (Sb+Sa)/Sa or (1.71+0.40)/0.40=5.275 as previously defined. The efficiency line 54a declines slowly from 100% with increasing Vg as more and more of the input energy follows the hydraulic side channel and would eventually asymptote to 0.92²=0.846 or roughly 85%. Hydraulic flow depicted by 53a rises slowly as Vg increases. Hydraulic pressure depicted by line 52a remains steady at 5781 psi throughout the under-dive (Ni/No>1) region as it is defined by the relationship:

$$P = \frac{2 π {T}_{i} {E}_{ma}}{{S}_{a}}$$

### Or

$$P = \frac{2 π ( 40 {0}_{in - lbs} ) ( 0.92 )}{0.4 {0}_{cubic inches / rev}} = 5781 psi$$

Sa is acting as a pump in this region and thus the P is reduced by the mechanical friction associated with Ema as friction always opposes motion and thus assists in transmitting the input torque from member 20 (reference FIG. 7) to the output member 41.

As the Vg percentage line 50 transitions below 0%, into negative values, the system becomes as per B-Output Coupled Ni/No<1 in FIG. 5. Power is now circulating backwards in the system and Sa becomes a motor driving Sb faster than Ni. Friction within Sa defined by Ema now works against torque transfer and the hydraulic pressure rises to 6830 psi as shown at 52b as Ema now moves from the numerator to the denominator in the pressure torque relationship. Efficiency line 54a drops rapidly as the system is now in the recirculation operating mode and is pretty much impractical as a drive at overdrive ratios (Ni/No<1) beyond 0.5:1.

At Vg %'s line 50 between −15% and −30%, as the system transitions from overdrive of approximately 0.5:1 to reverse of approximately −1:1, the speeds 51a and 51b, flows 53a and 53b and efficiency 54a and 54b are essentially unworkable such that this operational range will be avoided by control algorithms. FIG. 7 indicates a bypass valve 45 which will enable the flow generated by the input of Ni with the output a t No=0 in Sa to be circulated enabling an off or idle mode while Vg transitions across this zone. This bypass valve 45 could further generate a controllable pressure induced torque to enable a hill holding torque on the output To such that it could replace the torque converter used to couple the engine to the transmission used today on many construction and agricultural vehicles.

As the system operates in reverse mode between −1:1 and −3.25:1 the efficiencies shown by line 54b are lower that in forward ranges but workable. It should be mentioned that, since Ti determines the direction of pressure and does not change direction in reverse operation, the pressure as shown at 52c according to the stated equation does not change direction but rather returns to 5781 psi as Sa is again acting as a pump in reverse mode. Thus, the working pressures do not change polarity from forward to reverse modes as in input coupled power split or standard hydrostatic transmissions. This may afford some cost and complexity reductions but over-riding loads such as when a vehicle descends a steep grade need to be considered.

Now looking at FIG. 8b we again see the same efficiency lines 54a and 54b as in FIG. 8a. The efficiency 54b is lower than 54a but is workable and is rising as Vg % continues towards −100%. In reverse direction it is an asymptotic function again but there is an offset due to the relationship of To shown by line 57 and torque generated TSb by the variable Sb shown by line 56. The offset between 56 and 57 is equal to the fixed value of Ti but in forward mode Ti is added to TSb resulting in To and in reverse mode TSb-Ti=To. Again, efficiency is lower in reverse than forward but it is not a degenerative energy circulation situation like overdrive in forward but rather an offset as defined.

It should be appreciated that a system as described by FIGS. 7, 8a and 8b describe a fully functional CVT operable with high efficiency in both forward and reverse directions while providing an alternative to a traditional clutch or torque converter interface to the engine or prime mover. Only two low power, likely 12V PWM signals would be required to interface to the engine or prime mover. Only two low power, likely 12V PWM signals would be required to interface this transmission. One could control the pressure drop across the bypass valve 45 for coupling and decoupling the prime mover and the other would control % Vg or the device 38 swash plate angle.

Battery electric vehicles (BEV's) are propelled by motors which unlike internal combustion engines (ICE's) can produce maximum torque at zero rpm but their efficiency is very poor until 500-1000 rpm. If the power to mass ratio of the vehicle is high enough, the motor torque accelerates the vehicle through this low efficiency range into high efficiency operation so quickly and easily that typically BEV's have a single speed gear box with a ratio of perhaps 9:1. A typical BEV passenger vehicle may have a power to mass ratio of 300 kW to 1850 kg's or 0.16 kW/kg.

Heavy duty vehicles, such as Class 8 trucks, have a much lower power to mass ratio optimistically 500 kW to 36,000 kg or 0.014 kW/kg or less than 10% that of a BEV passenger vehicle. Multiple speed transmissions are being proposed for such powertrains as electric motor drives, despite their ability to generate torque at zero speed, would suffer potentially very poor efficiencies under acceleration and particularly at grade load conditions where the electric motor would otherwise be forced into a slow speed inefficient operational mode for extended periods, This is not just an efficiency issue but such operation would quickly overheat and destroy a single speed electric drivetrain.

If an electric powertrain in a vehicle with a low power to mass ratio as described above were equipped with a system such as described in FIG. 7, it could provide various higher gear ratios between the drive motor and the axles to maintain high efficiency operation in all such conditions. Further, if such a system as described by FIG. 7 were equipped with an overriding or dog clutch as shown by item 41b operably positioned between number 41 and pump 38 or Sb it could provide a means for pump Sb and its parasitic losses to be decoupled from the mechanism to allow maximum efficiency when the standard gearbox ratio between the electric propulsion motor and drive axle is adequate to allow efficient operation. This could allow a CVT operational condition lowering the Ni/No back to one as vehicle and motor speeds increased.

Transmissions are generally thought of to produce a torque multiplying effect such as the condition where Ni is greater than No or Ni/No>1 and thus accordingly To/Ti>1. This larger than one gearing ratio concept is generally defined as under-drive and is very widely used by mankind to allow engine torques to be multiplied to accelerate vehicles or for winching motors or hand-cranks to move heavy loads. However it should be recognized that devices that are primarily operating in Ni/No<1 gear ratios which are called over-drive are used to increase speed in devices such as centrifuges and very important lately speed increasing mechanisms used in large wind turbines. In wind turbines very large diameter and high inertia blades generate massive torques at very low speeds. Speed increaser transmissions are needed to increase the speeds of the turbine axis up to 1200 to 1800 rpm or more to allow a generator to produce 3 phase electric power at 50-60 Hz.

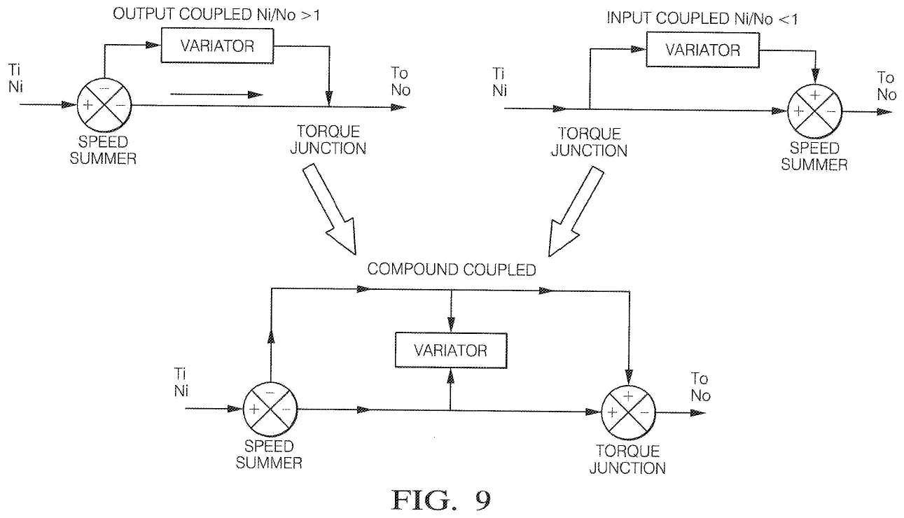

FIG. 9 defines a general arrangement in which the positives of both input and output coupled systems can be obtained with total avoidance of negative phenomenon of power circulation. If an output coupled system such as in FIG. 5D is combined with an input coupled system such as in FIG. 5A a hybrid or compound coupled system can be defined. In this case the system would have both an input and an output side speed summer and a common central torque junction and variator. In one embodiment a means to lock the input speed summer to prevent power flow to the side channel while coupling the variator only to the output coupled speed summer would create an input coupled system. The opposite arrangement would enable output operation. In a purely mechanical power split system where the speed summers are planetary or differential gearsets this would require the use of multiplicity of mechanical clutches.

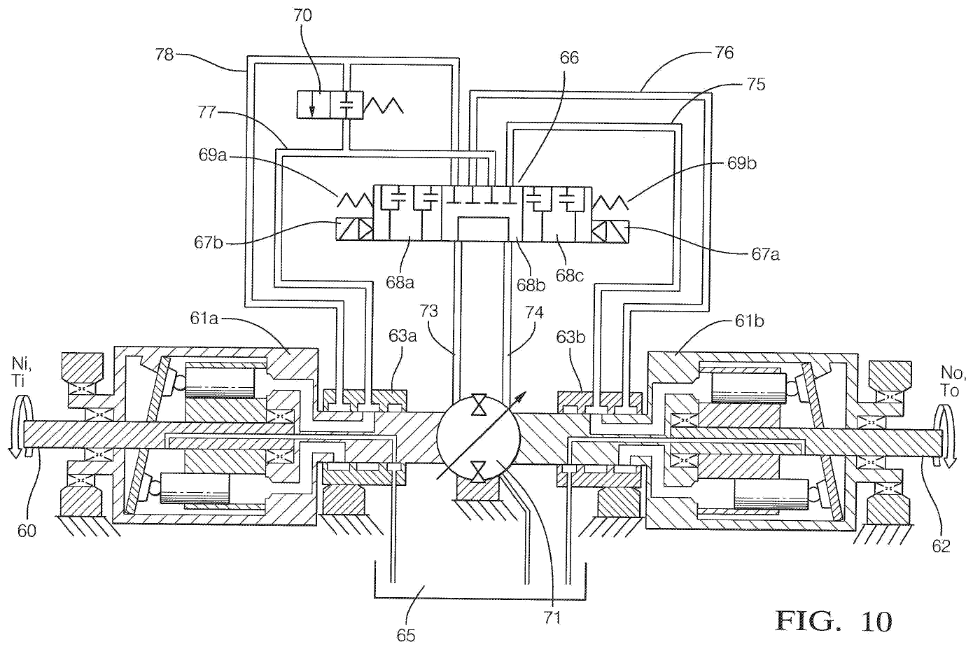

FIG. 10 describes a preferred embodiment in which the speed summers are hydraulic devices of the nature as described in FIG. 7 and associated text. Ni and Ti is received at input shaft 60. The cylinder block and pistons which rotate with 60 again as in FIG. 7 create a pump/motor with relative motion to member 61a both of which rotate coaxially. Rotary coupling 63a allows fluid to pass from this pump/motor to passage 77 and 78. These items thus comprise a speed summer junction as discussed before. Member 61a is integral to the shaft passing through the closed circuit over center variable displacement hydraulic device 71 and emerges on the other side as 61b. Coaxially rotating member 62 along with associated cylinder block and pistons creates motor/pump arrangement which in conjunction with rotary coupling 63b and passages 75 and 76 create a second speed summing junction. Rotary couplings 63a and 63b also contain passageways to allow drain flow to reach reservoir 65. Variable hydraulic device 71 is in communication with passages 73 and 74 which are connected to directional valve assembly 66. Also attached to directional valve 66 are passages 77 and 78 from the input side speed summer and passages 75 and 76 from the output side speed summer. Direction valve 66 has three operative positions, 68a, 68b and 68c. Return springs 69a and 69b make the center position 68b the default position. Solenoid actuator 67b when actuated places the valve in position 68a and solenoid actuator 67a places the valve in position 68c. There is also a controllable bypass valve 70 operable to freely allow passage of fluid between passages 77 and 78 or create a selected pressure drop ion the flow between them. Not shown is the auxiliary circuitry pump and associated check-valves and passages needed to return leakage to the pressurized working lines defined all of which are typical to closed circuit hydraulic circuits.

In operation, and assuming starting from zero vehicle speed, an input Ni at 60 would rotate its associated cylinder block and pistons. Solenoid 67b would be actuated putting the directional valve 66 in position 68a. In position 68a the valve 66 would connect to the speed summer comprised of members 60 and 61a through passages 77 and 78 in communication with variable displacement hydraulic device 71 through passages 73 and 74. Meantime in position 68a speed summer on the output side comprised of relative motion between members 61b and 62 would see passages 75 and 76 from their respective rotary coupling 63b blocked by position 68a of valve 66. This would essentially lock preventing relative motion between 61b and 62. Given that the torque developed at the load locks the then overall member 61a, being it is in the same member a 61b and 62 from turning, input rotation Ni at 60 results in fluid flow created by relative angular motion between 60 and 61a through rotary coupling 63a passages 77 and 78. While in zero output mode valve 70 would be actuated allowing this flow to recirculate through a short loop while member 61a remains stationary. If valve 70 is operational to create a controllable pressure drop to the flow moving from 77 to 78 a controllable torque can be applied the member 61a and thus the output system at 62. This would allow a vehicle to hold against a hill or other resistance with zero vehicle speed likely allowing elimination of the commonly used torque converter.

As movement in underdrive Ni/No>1 would occur at the beginning of vehicle movement, the direction valve 66 would remain at position 68a. The controllable swash plate angle in variable displacement hydraulic device 71 would be set preferably to the maximum angle and side of center which would allow the variable displacement hydraulic device 71 to receive flow from the input side speed summer 60 and 61a thus making device 71 function as a motor. As valve 70 would be deactivated the pressure drop from 77 to 78 would increase and the induced pressure would act as a torque in both member 61a and variable displacement hydraulic device 71 multiplying the input torque at now turning point output 62. Shortly thereafter, valve 70 would allow no further flow bypass between 77 and 78 as it completely closed.

The system would now be operating in an output coupled configuration as the swash plate angle of variable displacement hydraulic device 71 and thus hydraulic flow is reduced towards zero and the Ni/No ratio declines and approaches 1:1. There would be no circulation at this point as the direct mechanical power passing through 60 to 61a and hydraulic power passing through the rotary coupling 63a, passages 77 and 78, through passages 73 and 74 creating torque in variable displacement hydraulic device 71 would be additive.

A consideration in the design is that the pressure holding capability of the output positioned speed summer, comprised by relative motion between 61b and 62, has to be large enough displacement that the highest output torque of the system can be transmitted without exceeding pressure limitations. This might generally then define that the output side speed summer have a displacement in a range of a large fraction of the variable displacement hydraulic device 71's maximum displacement. Accordingly, given that as stated before that the maximum torque ratio of an output coupled system is To/Ti=(Sa+Sb)/Sa, the displacement per rev of the relative motion between number 60 and 61 may be on the order of 0.15 to 0.3 that of the variable displacement hydraulic device 71 at its full displacement.

As the swash plate of variable displacement hydraulic device 71 arrives at zero angle creating a 1:1 ratio it would be beneficial to deactivate solenoid 67b such that the directional valve would center at position 68b. In this position both front and rear speed summers become hydraulically locked and passages 73 and 74 are connected in valve 66 at position 69b completely unloading device 71 and removing any torque or associated leakage for maximum system efficiency at 1:1 ratio.

Now to achieve overdrive ratios (Ni/No<1) solenoid 67a would activate bringing valve 66 to position 68c. In this valve position pump lines 73 and 74 are put into communication with lines 75 and 76. Meanwhile lines 77 and 78 are blocked. In this condition members 60 and 61a are locked together and members 61b and 62 can turn relative to each other to accept flow from the device 71 which now has its swash plate angle to the other side of zero acting as a pump and sending flow through passages 73 and 74 and further to passages 75 and 76. In this condition the system is operating in an input coupled mode. Now the speed caused by hydraulic flow pumped by 71 causes a speed between 62 and 61b which is additive to the input speed Ni. Again, the power flows are additive. No recirculation is occurring.

It may be advantageous as an additional embodiment to add a clutching mechanism such as a dog clutch operable to lock 61b and 62 together. This would allow the high torques produced in underdrive mode to be carried independent of hydraulic holding power when the directional valve 66 is in position 68c. This would be advantageous in the case that the hydraulic displacement defined by the relative rotation of 61b and 62 is desired to be small enough such that much higher output speeds at 62 could be achieved in overdrive.

We have now described a compound coupled power split transmission which would have its highest efficiency at 1:1 ratio but would remain at slowly declining efficiencies in both directions. In both directions the efficiency would asymptote towards the efficiency of the hydraulic power transfer branch. For reverse, the system would be placed in output coupled mode with valve 66 in position 68a operating as described in FIGS. 7, 8a and 8b.

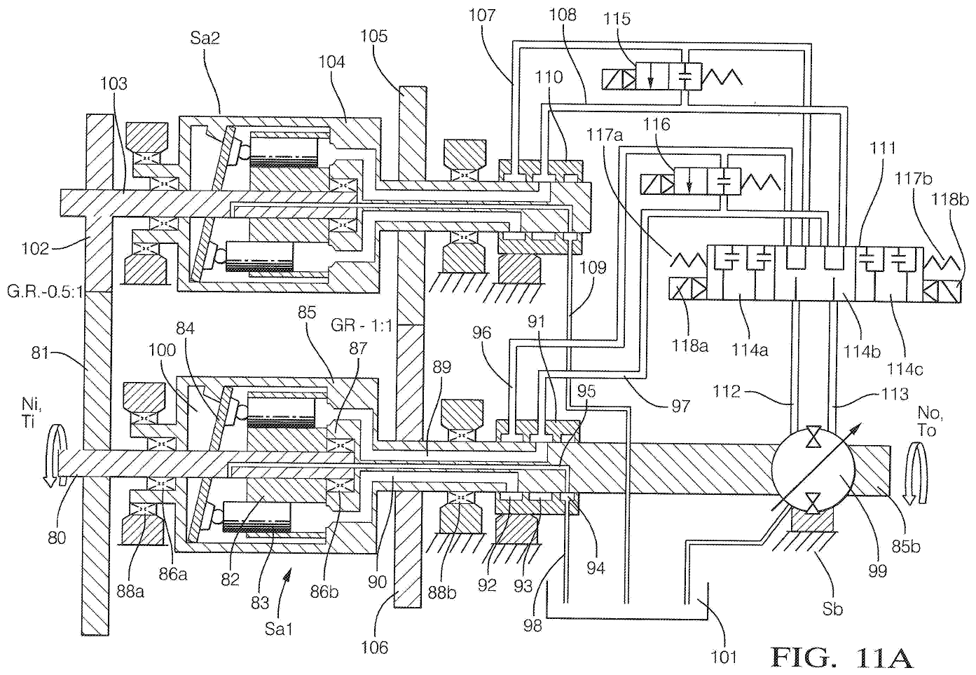

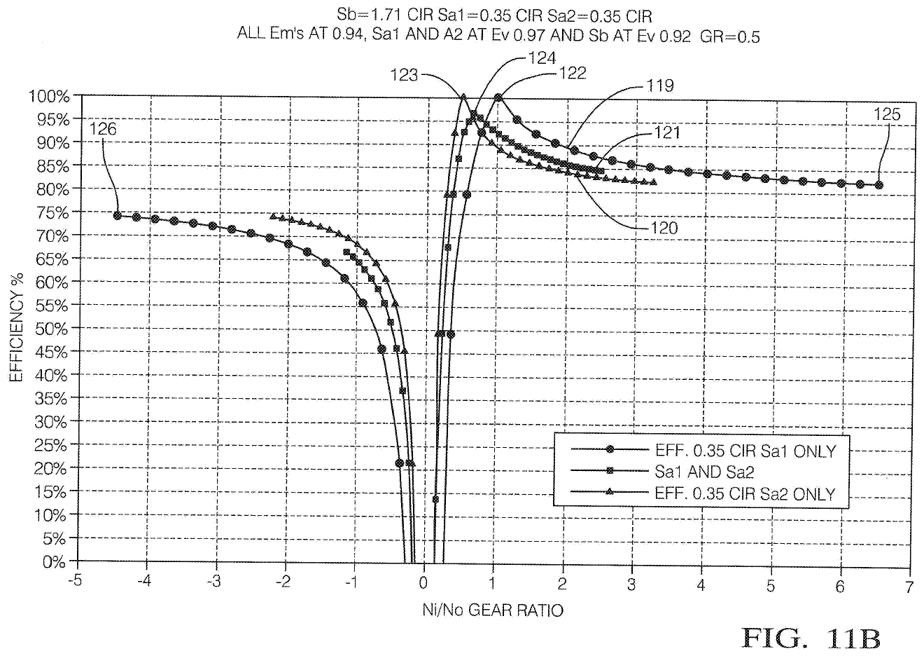

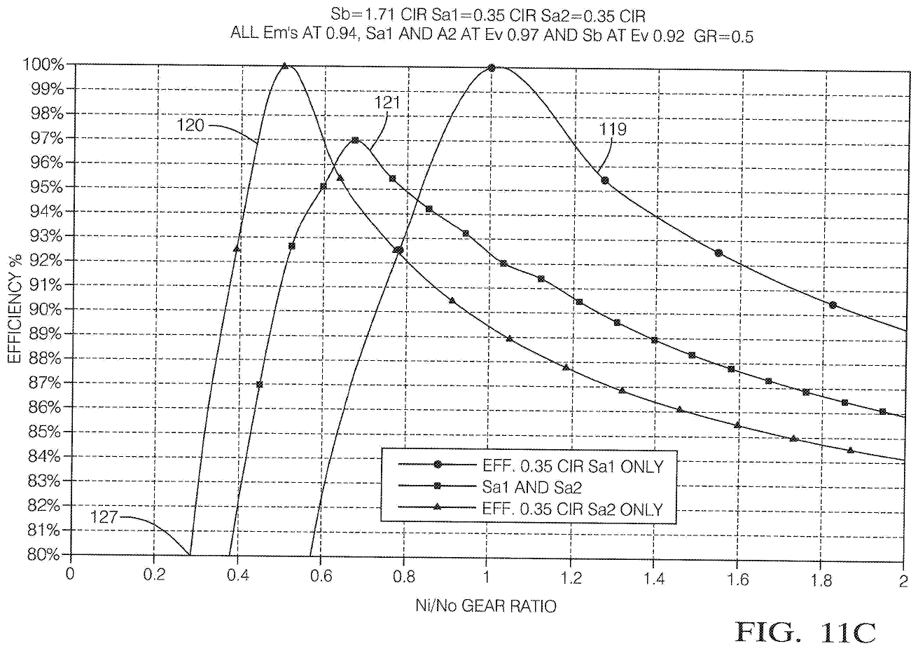

Another embodiment of the invention is a further development of FIG. 7 and is described in FIGS. 11A-11C. Looking first to FIG. 11a there is an input Ni and Ti on rotating shaft member 80. Affixed to and rotating with 80 are gear 81 and cylinder block 82. Moving axially within cylinder block 82 are a multiplicity of pistons (typically 9) such as shown at 83. Given that these pistons ride on angle plate 84 which is mounted in 85 which is in turn rotating coaxially with member 80 and affixed members it includes a sinusoidal motion on the pistons 83. Member 80 and affixed members 81 and 82 are positioned and allowed rotation by bearings 86a and 86b. Member 85 and associated members rotate coaxially as supported and positioned by bearings 88a and 88b. Also, member 85 extends through closed circuit over center variable device 99 to comprise the output shaft member 85b. All comprised within member 85 is a valve plate surface 87. Further included in member 85 are passages 89, 90 and 95 which conduct fluid to rotary couplings 91. Within rotary coupling 91 are passageways 89,90 and 95 which carry fluid to rotary coupling 91. Within rotary coupling 91 are concentric cavities 92, 93 and 94 which allow communication to fluid passages 96, 97 and 98. Fluid passages 96 and 97 carry the working flow and conduit 98 is a drainage passage allowing leakage from cavity 100 to travel to reservoir 101.

As previously discussed in relation to FIG. 7, as members 80 and 85 and their associated members rotate relative to each other. A volume of oil is displaced by the sinusoidal axial movement of pistons 83. Further given pressure resistance to such flow, pistons 83 in combination with plane 84 will create a torque operative between members 80 and 85. The volumetric displacement and torque producing mechanism thus described will be denoted as Sa1.

Illustrated in FIG. 11a directly above Sa1 is a similar or identical mechanism pictorial denoted generally as Sa2. A gear 81 affixed to member 80 engages a gear 102 attached to shaft 103. Together the gears create a −0.5:1 ratio between input shaft 80 and shaft 103 within Sa2. On the right-hand side of general assembly Sa2 is a gear 105 affixed to member 104. Gear 105 meshes with gear 106 which is affixed to member 85 of Sa1. Together they link members 85 and 104 together at a GR of −1:1.

Equivalent to Sa1, Sa2 has working passages 107 and 108 and drain passage 109 conveying fluid from rotary coupling 110. Passages 107 and 108 attach to a three-position operational mode valve 111. Lines 112 and 113 connect valve 111 to a closed circuit over center variable device 99. Also, lines 96 and 97 connect Sa1 to the 111 valve as well. Valve 111 has three operational positions 114a, 114b and 114c. Two springs 117a and 117b center the valve at position 114b. Solenoids 118a and 118b can be actuated to put the valve into positions 114a and 114c. Finally, bypass valves 115 and 116 can operatively shunt line 108 to 107 and 97 to 96, respectively.

Thus, the configuration is very similar to that of FIG. 7 because they are both output coupled systems as defined by FIG. 5B and FIG. 5D Figure, however, the embodiment described as such in FIG. 11a has two speed summers Sa1 and Sa2 driving the main output member 85/85b and, thus, device 99 at different drive speeds as defined by the two gear ratios. Given, the displacements of Sa1 and Sa2 as units of volumes swept per unit of relative motion between their respective halves (i.e. 80 to 85 and 103 to 104) the flows swept by either would be defined as follows:

$$Qsa 1 = ( N i - N o ) Sa 1 \\ Qsa 2 = ( N 1 / GR - No ) Sa 2$$

Further given that device 99 or Sb will have some controllable and variable displacement either positive or negative dependent on its swash plate control angle, the output speed or No would thus generally be predicted by the relationship as follows:

$$No = ( Qsa 1 + Qsa 2 ) / Sb$$

Valve 111 selectively allows either or both of these flows to be directed in/out of device 99 via lines 112 and 113. Valve position 114a allows Sa1 to communicate with device 99 while isolating Sa2. Valve position 114a allows Sa2 to communicate with device 99. Valve position 114b allows the flows to be combined, however, it must be recognized that depending on displacements, gear rations and relative speeds of each of Sa1 and Sa2's respective halves, these flows may be additive or differential thus cancelling each other out.

In valve position 114a one can recognize that the conduits in and out of Sa2 are blocked and likewise in position 114c flow in and out of Sa1 is blocked. When the flow in and out of units Sa1 and Sa2 are blocked it essentially locks the two halves together preventing relative motion such that Ni and No are locked either at 1:1 ratio in the case of Sa1 or at GR:1 ratio in the case of Sa2. If both are locked the system will bind and/or lock up thus valves 115 and 116 can controllably allow a shunted flow to occur allowing either Sa1 or Sa2 top transmit essentially zero torque.

FIG. 11B indicates an analysis of the described configuration. Line 119 describes the projected efficiencies of the system when the valve position 114a as function of Ni/No or gear ratio when only Sa1 is operating and valve 115 is actuated to allow Sa2 to freewheel. Line 120 depicts the system in valve position 114c where only Sa2 is operative and valve 116 is actuated to allow Sa1 to freewheel. Line 121 depicts the system in valve position 114b when both Sa1 and Sa2 are active and the flows combine in the center of valve 111 in communication with pump 99. The Ni/No range depicts the impact of full positive and negative swash plate angle on Sb thus 1.71 to −1.71 CIR displacement.

With just Sa1 active peak efficiency occurs at Ni/No=1.1 as shown at 122. With just Sa2 active and recalling the −0.5:1 gear ratio between shafts 80 and 103 efficiency peaks at Ni/No of 0.5:1 ratio at point 123. When both motors are active the peak efficiency occurs at approximately 0.67:1 as shown at point 124 however it can be noted that has a decrease in max efficiency of approximately 2% less than the other two cases. That is because at point 124 QSa1 has become negative No is greater than Ni but not greater than Ni/GR. Thus, a negative QSa1 is combining and cancelling out QSa2 of approximately the same positive magnitude. This flow interaction at this operating point does not propel the output shaft and is only a source of in-efficiency. The output torque however is still positive despite no flow to or torque generated by device 99 (Sb) because torques of both Sa1 and Sa2 are still being applied to the output shaft member 85/85b.

Operation on only Sa1 shown by line 119 provides the greatest range of gear ratios in both positive and negative directions. Point 126 indicates about 74% efficiency at Ni/No=−4.5 which means output torque would be about 3.33× input torque which however is not as good in the forward direction is quite acceptable. Point 125 indicates about 82% efficiency at Ni/No of 6.5 which means 5.3× input torque which is quite acceptable also.

As mentioned before the efficiency over on the over drive ratio side Ni/No<1 plummets rather quickly on an output coupled system. In this case operation with the second drive Sa2 through a −0.5:1 gear ratio helps extend the range.

Now looking at FIG. 11C we have expanded the scales to take a closer look at impact above and below the 1:1 ratio-point where many transmissions (i.e. cars and light trucks) spend a vast majority of their percentile-based usages. The same three curves 119, 120 and 121 are portrayed on a now expanded scale. It can be seen at point 127 on curve 120 that an efficiency of about 80% could still be maintained at an Ni/No of 0.28:1 over drive. Thus, such a configuration could provide CVT function from 6.5:1 underdrive to 0.28:1 overdrive for a ratio range of 23×. This well exceeds the reach of most transmissions today, CVT or not, while still providing a continuous CVT control from end to end including reverse and overdrive. Further, the use of Sa1 and Sa2 together could fill the gap in the middle as shown by line 121. This could provide then >94% efficiency between 0.4:1 and 1.4:1 with CVT control. Further combination use of valves 115 and 116 along with valve 111 could provide full locked conditions at 0.5:1 and 1:1 points allowing even higher efficiencies. Further, as aforementioned output coupled power split transmissions do not have an ability to provide No=0 such that valve 116 could function as an electronically variable torque-controlled clutch for transitions from idle to low speeds eliminating the need for a torque converter.

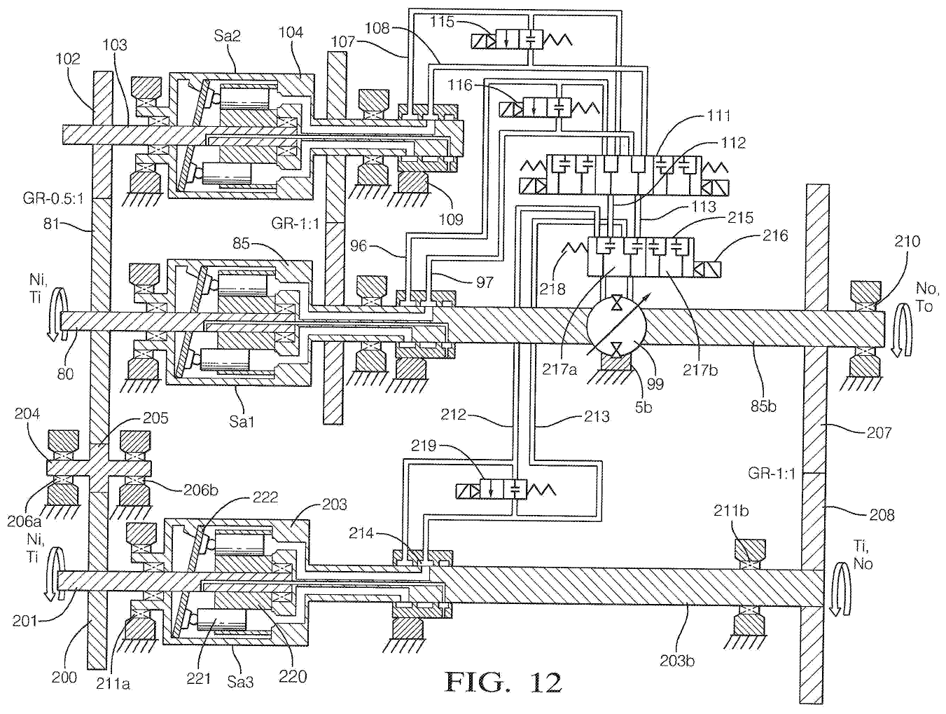

Yet another embodiment of the general application of the invention is illustrated in FIG. 12. This enhancement on the configuration of FIG. 11a-c places another parallel power path Sa3 in the network with Sa1 and Sa2. The overall input shaft 80 has as aforementioned gear 81 affixed. There is now positioned an axle 204 supported by bearings 206a and 206b. Affixed to axle 204 is gear 205 which engages 81 as well as another gear 200 which is affixed to shaft 201. Shaft 201 is affixed to cylinder block 220 which contains a multiplicity of pistons 221 which riding on angled plate 222 embedded in 203 along with relative angular motion of 220 to member 203 create a volumetric displacement of fluid which is passed through rotary coupling 214. Member 203 and by extension shaft 203b comprises as a stated part of this pumping mechanism and is positioned and supported by bearings 221a and 211b. Together these members constitute mechanism Sa3.

Further affixed to shaft 203b is gear 208 which engages gear 207 which is affixed to the overall output shaft 85B. Newly added volumetric displacement mechanism Sa3 along with the gear train comprised of gears 81, 205, 200, 208 and 207 provide for a mechanical drive path for power to output shaft 85b in the opposite direction of input shaft 80. This mechanical power path through Sa3 together with closed circuit over center variable device 99 or Sb, and yet to be described associated passageways and valves, create an output coupled power split transmission configured to enhance operational efficiency in the reverse operation direction. The gear ratio between gears 81 and 200 is portrayed to be essentially 1:1 with the purpose of gear 205 being strictly to reverse direction but could take other values depending on the perceived needs of the designer as to the desired tradeoffs between forward and reverse operations.

Rotary coupling 214 allows communication of working flows from overall mechanism Sa3, which we may remind the reader constitutes a speed summing junction, to conduits 212 and 213. Conduits 212 and 213 interface forward/reverse directional valve 215. Valve 215 provides selectively whether forward biased speed summing mechanisms Sa1 and Sa2 or reverse biased speed summer Sa3 are in communication with a variable over center device 99 aka Sb through conduits previously defined as 112 and 113 in FIG. 11a which are now interrupted by valve 215. Valve 215 has two positions, 217a and 217b. The spring 218 returns the valve to the reverse operation position connecting 212 and 213 to device 99 aka Sb while the solenoid control 216 moves the valve to the left in forward operation position putting original conduits 112 and 113 in communication with device 99 aka Sb. Valve 219 allows a bypass for device Sa3 when the overall system is operating in the forward direction. This would equate to usage of valves 115 and 116 selectively activated as beneficial in the forward modes of operation. Again, restriction of valves, either 116 in the forward direction or 219 in the reverse direction could allow very low speed operation and/or provide electronically controlled precision torque application eliminating the need for any other clutching or torque converter in interface to the system prime mover.

Overall reverse direction operation using Sa3 would be equivalent to forward direction operation using Sa1 and both would be predicated by the same general operational characteristic as is illustrated in FIGS. 11b-c by curve 119 and point 122, except with opposite directions of output. Thus, the lower efficiency of point 126 in FIG. 11B could be 85% or better instead of 75%. Thus, this system as illustrated and explained according to FIG. 12 could be most applicable to a construction or materials handling vehicle which may spend a considerable portion of its operation time in lower speeds in reverse and thus would want higher efficiencies there. Further, such a vehicle would still benefit from the higher speeds allowed by use of speed summer Sa2 in the forward direction by enabling efficient overdrive operation depicted by curved 120 and 121 in FIG. 11B. This would be advantageous too on road operation or generally moving from place to place at a worksite. It is recognized that the gearing and valving illustrated and explained related to the device of FIG. 12 is cumbersome and less than optimal efficiency and perhaps somewhat redundant. However, the overall benefit of being able to switch the bias of the mechanical power path necessary to allow power split transmission operation from forward to reverse direction is along with a design solution is defined.

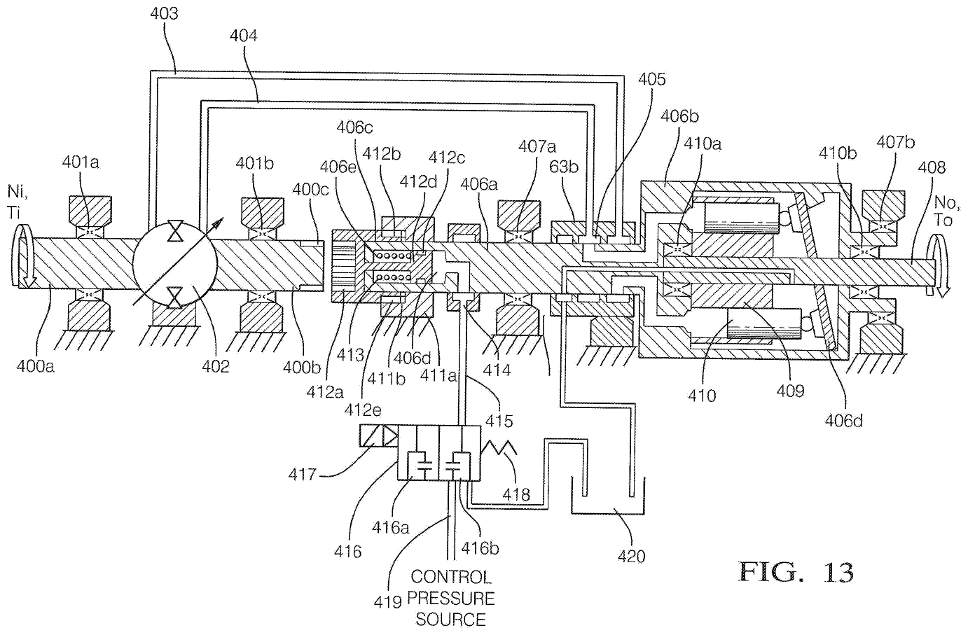

FIG. 13 defines a cross-section of a final embodiment of the present invention. However, in this case it is an input coupled configuration as per FIG. 5A or C. An input Ni and Ti is received from a power source on rotating member 400a which comprises a thru shaft including member extension 400b to variable displacement hydraulic device 402. Rotating member 400a and 400b is supported and constrained by bearings 401a and 401b. On the far-right end of member 400b are external spline grooves 400c. Fluid conduits 403 and 404 put device 402 in fluid communication with rotary coupling 405.

A second rotating member represented by 406a-e is supporting and constrained by bearings 407a and 407b to be concentrically aligned with member 400a-c. On the far-left end of member 406 are external spline grooves 406c. A third rotating member shaft 408 is supported by bearings 410a and 410b within and coaxial to member(s) 406. Member 408 comprises the output of the device and thus is coupled to provide No and To to a load. A cylinder block 409 is affixed to turn with shaft 408. Within cylinder block 409 are a multiplicity of pistons 410. The pistons 410 are driven by an angled plane 406d to a sinusoidal axial motion by relative angular motion between member(s) 406 and members 408/409. This sinusoidal motion then is proportional to flow moving through passages within member 406b allowing fluid communication with rotary coupling 405 and thus conduits 403m and 404 and to device 402.

Positioned between external spline grooves 400c and 406c is dog clutch mechanism 412 with leftward opening internal splines 412a and rightward opening internal splines 412b. Positioned concentric to rotating member 406a and stationary to ground is dog collar 411a. On the inner diameter of dog collar 411a are internal spline grooves 411b. The number of spline grooves and tangs and the geometry thereof of 400c to 412a and 406c to 411b are set respectively to provide for slid-able engagement regardless of axial position of dog clutch 412. Dog clutch 412 is also comprise of hydraulic piston 412d constructed to traverse axially within bore 406d. There is further an O-ring groove and O-ring 412c to prevent any leakage between piston 412d and bore 406d. A coil spring 413 positioned between piston 412d and bore end 406e to move piston 412d and thus overall dog clutch members 412 to the right when hydraulic pressure on piston 412d is dismissed. Volume to the right of the piston 412d in bore 406d is in fluid communication to rotary coupling 414 and further to conduit 415. Conduit 415 interfaces two position electrically controllable valve 416.

Valve 416 is operable to place conduit 415 in communication to a pressure source through conduit 419 when in position 416a given solenoid control 417 activation. Or place conduit 415 in communication with reservoir 420 in position 416b via return spring 418 when solenoid 417 is not activated.

Now defining the operation of the device of FIG. 13. With solenoid 417 inactive spring 418 would push valve 416 to position 416b as shown in the figure which would connect 415 to reservoir 420 thus pressure in bore 406d would be low. Spring 413 thus pushing from spring seat 406e would move piston 412d to the right also as shown in the figure. In this position external splines 412e, would now also engage with internal spline grooves 411b of stationary dog collar 411a. Thus, in this position of the valve and dog clutch, the overall rotating member 406 would be locked to the ground.

In this state member 406b would essentially become the housing of a stationary axial piston hydraulic motor with rotating cylinder block 409 and output shaft 408 driving load No and To relative to ground. Hydraulic device 402 driven by input shaft 400a in fluid communication with motor 406c and output shaft 408 through conduits 403 and 404 would thus create a typical hydrostatic transmission configuration. This may be an advantage for low speed and reverse operation as well as to provide a more stable zero output state by reducing the displacement of device 402 to zero and also locking the output shaft 408 to prevent motion of any kind.

Now if solenoid 417 is activated, valve 416 will move to position 416a placing conduit 415 in communication with a pressure control source at conduit 419. This will, in turn, create pressure through 415 and rotary coupling 414 pushing within bore 406d against piston 412d. Piston 412d will be forced to the left compressing spring 413, and thus the splines 412b will disengage from spline grooves 411b of stationary dog collar 411a. As the piston 412b and dog clutch 412 assembly in general move further leftward splines 412a will engage external spline grooves 400c of overall input rotating member 400. With splines 412a engaged to shaft 400 overall member 406 will turn at speed Ni and a power split transmission configuration will be enabled for more efficient forward direction operation.

The timing of this transition would require some control algorithms to synchronize the speeds of the two rotating members for engagement and disengagement.

In agricultural and construction applications electrification of the powertrains causes some unique issues. Many such applications require extremely high drive-wheel torques which are not typically directly producible by electric drive motors even with a 10× or more gear reductions. In these cases hydraulic final drive-wheel outputs are the only reasonable design approach to meet the requirements. This however infers that a central electrically driven hydraulic source sends hydraulic flow at high pressure to each of many potentially remote mounted drive-wheels. Conversion of this battery originated power through an electrically driven central hydraulic pump and eventual conversion back to high torque and low drive speed of each the drive wheels could easily result in losses of 25% or more of the energy. If individual speed/traction control of each of these drive wheels is required a variable motor device would be additionally required at each drive wheel.

Application of an embodiment such as defined in FIG. 13 and the afore-mentioned text could be very appropriate to solve the problem of the high efficiency, high drive ratio range and extremely high output torque requirements of such agricultural and construction vehicles as they are electrified in the coming decades. An electric motor drive at each of the vehicle's drive-wheels coupled through a speed-reducing gearbox, which would have an output speed and torque combination appropriate for higher vehicle speeds, would be the input on shaft 400a of the device of FIG. 13's embodiment. Output shaft 408 would essentially be the drive wheel hub.

Then for higher vehicle speed ranges the clutch 412 would engage to the left and couple the input from the electric drive speed reducing gearbox on shaft 400a to the through shaft member 406a-d. The variable hydraulic device 402 would be set at zero displacement preventing hydraulic flow and essentially locking members 406a-d to wheel drive shaft 408 constrained by cylinder block 409 and pistons 410 together. This would allow an extremely efficient electric drive powertrain for higher vehicle speed ranges. Thus, there would be direct distribution of efficient electric power to each of many remote drive wheels. As drive wheel torque requirements increase the displacement of device 402 would move off the zero-angle point allowing hydraulic flow and putting the powertrain into an electric mechanical and hydraulically driven power-split operating range which would be less efficient than the higher speed direct electric drive but much more efficient than central hydraulic power distribution. As drive wheel torque requirements increase further the clutch 412 would be shifted to the right locking the shaft 406a-d to ground and now creating a hydrostatic drive where the output of the speed-reducing gearbox would be only driving shaft 400a and associated pump 402. The hydraulic motor comprised of now locked to ground housing 406b and cylinder block 409, pistons 410 and output shaft 408 could now create very high torques direct to the drive wheel hub.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A transmission comprising:
a first rotating member, such as a shaft, coupled to receive power from a source:
a second rotating member constrained to rotate coaxially with the first rotating member;
a positive displacement hydraulic mechanism such as an axial piston device with portions thereof positioned on and between said first and second members such that a volume is displaced and thus hydraulic flow by relative angular motions between them;
a plurality of rotary couplings positioned on either first, second or both said rotating members in fluid communication to receive or disperse said hydraulic flow; and
a variable displacement hydraulic mechanism in fluid communication with said rotary couplings and coupled to said second rotating member.

2. The device of claim 1 further comprising a load coupled to said second member.

3. The device of claim 1 further comprising:
a third rotating member such as a shaft constrained to rotate coaxially with the second rotating member;
a positive displacement hydraulic mechanism such as an axial piston device with portions thereof positioned on and between said second and third members such that a volume is displaced and thus hydraulic flow by relative angular motions between them;
a second plurality of rotary couplings positioned on either second, third or both said rotating members in fluid communication to receive or disperse said hydraulic flow to said variable displacement hydraulic mechanism; and
a load coupled to said third member.

4. A transmission comprising:
a first rotating member to receive power from an external source;
said first rotating member being coupled to one channel of a 3-channel speed summing junction and transferring said power into said junction;
a second rotating member coupled to another channel of said speed summing junction;
said second rotating member further being coupled to an output to send said power to a load; and
means capable to send or receive the differential in power between said first and second rotating members to a stationary mechanism and accordingly constrain motion of the third channel of the speed summing junction.

5. The device of claim 1 further comprising a third rotary coupling operably constructed to provide a passage to reservoir from the positive displacement hydraulic mechanism to accommodate leakages.

6. The device of claim 1 further comprising a controllably restrictive valve between the passages containing said rotary couplings and in parallel with the positive displacement hydraulic device.

7. The device of claim 1 further comprising a selectively controllable clutch operable between said second member and variable displacement hydraulic mechanism.

8. The device of claim 1 further comprising an overturning Sprague clutch positioned between said second rotating member and variable displacement hydraulic mechanism allowing relative movement between them in only one direction.

9. The device of claim 3 further comprising a clutch between third rotating member and second rotating member.

10. The device of claim 9 further including said clutch being an overturning Sprague clutch allowing relative movement in only one direction.

11. The device of claim 9 further including said clutch being a controllable dog clutch.

12. The device of claim 3 further comprising conduits between said rotary couplings and said variable displacement hydraulic mechanism containing valves.

13. The device of claim 12 wherein said valves being check valves.

14. The device of claim 12 wherein said valves being electrically controllable restrictions.

15. The device of claim 1 further comprising:
a third rotating member coupled mechanically to said first rotating member;
a fourth rotating member constrained to rotate coaxially with the third rotating member;
a positive displacement hydraulic mechanism such as an axial piston device with portions thereof positioned on and between said third and fourth members such that a volume is displaced and thus hydraulic flow by relative angular motions between them;
a second plurality of rotary couplings positioned on either third, fourth or both said rotating members in fluid communication to receive or disperse said hydraulic flow; and
said fourth member further mechanically coupled to said second rotating member.

16. The device of claim 15 further comprising:
valves in communication with both pluralities of rotary couplings associated with flow produced by relative motion of first and second rotating members as well as flow produced by relative motion produced by relative motion of third and fourth rotating members; and
said valves allow selectively either flow from members one and two or members three and four or both to communicate with said variable displacement hydraulic mechanism.

17. The device of claim 16 wherein said valves controllably able to block flow produced by either relative motion of rotating members one and two or three and four thus selectively preventing angular movement between either rotating members one and two or rotating members three and four.

18. A transmission comprising:
a first rotating member, such as a shaft, coupled to receive power from a source;
a second rotating member constrained to rotate concentric with the first rotating member;
a third rotating member constrained to rotate coaxially with the second rotating member and further coupled to a load;
a positive displacement hydraulic mechanism such as an axial piston device with portions thereof positioned on and between said second and third members such that a volume is displaced and thus hydraulic flow by relative angular motions between them;
a plurality of rotary couplings positioned on either second, third or both said rotating members in fluid communication to receive or disperse said hydraulic flow;
a variable displacement hydraulic mechanism in fluid communication with said rotary couplings and coupled to said first rotating member;
a clutch operable to couple said second member to said first member; and
a clutch operable to lock said second rotating member stationary relative to ground.

19. The device of claim 4 further comprising a variable coupling to send or receive said differential power between said stationary mechanism and said first rotating member via a torque reaction to ground.

20. The device of claim 4 further comprising a variable coupling to send or receive said differential power between said stationary mechanism and said second rotating member via a torque reaction to ground.

21. The device of claim 4 further comprising construction such that when said differential power is zero the speed ratio between said first and second rotating members is 1:1.

22. The device of claim 4 wherein said speed summing junction is constructed of geared interfaces.

23. The device of claim 18 further wherein said source of power is an electric drive motor.

24. The device of claim 23 further comprising a speed reducing gearbox between said electric drive motor and said first rotating member.

25. The device of claim 1 wherein the said source of power is an electric drive motor.

26. A power transfer device comprising:
a first rotating member coupled to receive power from a wind turbine;
a second rotating member constrained to rotate coaxially with the first rotating member;
a positive displacement hydraulic mechanism such as an axial piston device with portions thereof positioned on and between said first and second rotating members such that a volume is displaced and thus hydraulic flow by relative angular motion between them;
a plurality of rotary couplings positioned on either first, second or both said rotating members in fluid communication to receive or disperse said hydraulic flow from the rotating members; and
a variable displacement hydraulic mechanism in fluid communication with said rotary couplings and coupled to said first rotating member.

27. The device of claim 26 further wherein said second shaft is coupled to an electric generator.

28. The device of claim 26 further comprising a speed increasing gearbox positioned to couple said wind turbine to said first rotating member.

29. The device of claim 15 further comprising:
a fifth rotating member mechanically coupled to the first rotating member;
a sixth rotating member constrained to rotate coaxially with the fifth rotating member;
a positive displacement hydraulic mechanism such as an axial piston device with portions thereof positioned on and between said fifth and sixth rotating members such that a volume is displaced and thus hydraulic flow by relative angular motion between them;
a plurality of rotary couplings positioned on either fifth, sixth or both said rotating members in fluid communication to receive or disperse said hydraulic flow from the rotating members; and
a mechanical coupling between said sixth and second rotating members which induces rotation which is opposite in direction to the input rotational direction on the first rotating member.

30. A transmission device comprising:
a first rotating member configured to receive power from an external source;
a second rotating member juxtaposed with said first rotating member and configured to receive the same level of torque as said first rotating member, but a lesser angular excursion, angular speed and, thus, a lesser amount of power;
means operative to transfer the power difference between the first member and the second member;
means to receive the power difference and convert said power difference into a new torque and speed product where new speed matches the speed of the said second rotating member; and
means to operative to add the new quantity of torque to said second rotating member.

31. The device of claim 1 further comprising conduits disposed between said rotary couplings and said variable displacement hydraulic mechanism.

32. The device of claim 31 further comprising controllable valves in series in said conduits.

33. The device of claim 31 further comprising controllable valves in parallel across said conduits.
